(19) United States
(12) Patent Application Publication
(10) Pub. No.: US 2025/0050337 A1
(43) Pub. Date: Feb. 13, 2025

(54) DROPLET DRIVING METHOD AND APPARATUS BASED ON A MICROFLUIDIC CHIP, SYSTEM, DEVICE, AND MEDIUM

(71) Applicant: Shanghai Tianma Microelectronics Co., Ltd., Shanghai (CN)

(72) Inventors: Xiao CHEN, Shanghai (CN); Ping SU, Shanghai (CN); Baiquan LIN, Shanghai (CN); Huihui JIANG, Shanghai (CN); Qingsan ZHU, Shanghai (CN)

(73) Assignee: Shanghai Tianma Microelectronics Co., Ltd., Shanghai (CN)

(21) Appl. No.: 18/925,505

(22) Filed: Oct. 24, 2024

(30) Foreign Application Priority Data
Mar. 19, 2024 (CN) . 202410317398.5

(51) Int. Cl. B01L 3/00; G06F 3/0484

(52) U.S. Cl. CPC B01L 3/50273; G06F 3/0484; B01L 2200/061; B01L 2300/0816; B01L 2400/0415

(57) ABSTRACT

A droplet driving method includes displaying a droplet path editing interface in response to a droplet path editing request, where the droplet path editing interface at least includes a path planning window; receiving a path selecting operation in the path planning window and displaying, in the path planning window, the droplet moving path information corresponding to the path selecting operation; controlling a driving signal for the microfluidic chip according to the droplet moving path information to drive a droplet to move along a moving path corresponding to the moving path information when the microfluidic chip receives the driving signal.

### CROSS-REFERENCE TO RELATED APPLICATION(S)

This application claims the priority of a Chinese Patent Application No. 202410317398.5, filed on Mar. 19, 2024, the disclosure of which is incorporated herein by reference in its entirety.

### TECHNICAL FIELD

Embodiments of the present application relate to the field of microfluidic technology, in particular, a droplet driving method and apparatus based on a microfluidic chip, a system, a device, and a medium.

### BACKGROUND

A microfluidic apparatus can drive a droplet to move so that the microfluidic apparatus can process and analyze a liquid sample. Moreover, the microfluidic apparatus has characteristics such as fast analysis speed, low loss, low material consumption, and low pollution when processing and time-sharing samples. Therefore, the microfluidic apparatus has a very wide prospect in many fields such as biomedical research, drug synthesis and screening, environmental monitoring and protection, health quarantine, judicial identification, and biological reagent detection.

The current microfluidic apparatus includes a microfluidic chip and a driver chip installed on the microfluidic chip. A corresponding driver program is burned into the driver chip so that the driver chip provides a driving signal to the microfluidic chip based on the burned program to drive a droplet on the microfluidic chip to move.

However, when a corresponding driving signal is provided to the microfluidic chip according to the burned program, the driving signal can only control the droplet to move in a single path and cannot meet the needs of diverse movement routes.

### SUMMARY

Embodiments of the present application provide a droplet driving method and apparatus based on a microfluidic chip, a system, a device, and a medium.

In a first aspect, embodiments of the present application provide a droplet driving method based on a microfluidic chip. The droplet driving method based on a microfluidic chip includes the steps below.

A droplet path editing interface is displayed in response to a droplet path editing request; the droplet path editing interface at least includes a path planning window.

A path selecting operation in the path planning window is received, and in the path planning window, the droplet moving path information corresponding to the path selecting operation is displayed.

A driving signal for the microfluidic chip is controlled according to the droplet moving path information to drive a droplet to move along a moving path corresponding to the moving path information.

In a second aspect, embodiments of the present application also provide a droplet driving apparatus based on a microfluidic chip. The droplet driving apparatus based on a microfluidic chip includes an interface display module, a path display module, and a signal control module.

The interface display module is configured to display a droplet path editing interface in response to a droplet path editing request; where the droplet path editing interface at least includes a path planning window.

The path display module is configured to receive a path selecting operation in the path planning window and display, in the path planning window, the droplet moving path information corresponding to the path selecting operation.

The signal control module is configured to control a driving signal for the microfluidic chip according to the droplet moving path information to drive a droplet to move along a moving path corresponding to the moving path information.

In a third aspect, embodiments of the present application also provide an electronic device.

The electronic device includes at least one processor and a memory.

The memory is in a communication connection with the at least one processor.

The memory stores a computer program executable by the at least one processor, and the computer program is configured to, when executed by the at least one processor, cause the electronic device to execute the preceding droplet driving method.

In a fourth aspect, embodiments of the present application also provide a droplet driving system. The droplet driving system includes a microfluidic chip and a host computer.

The host computer is connected to the microfluidic chip, and the host computer is configured to execute the preceding droplet driving method.

In a fifth aspect, embodiments of the present application also provide a computer-readable storage medium, storing computer instructions that, when executed by a processor, implement the preceding droplet driving method.

### BRIEF DESCRIPTION OF DRAWINGS

FIG. 1 is a top view of the structure of a microfluidic chip according to one or more embodiments of the present application.

FIG. 2 is a sectional view illustrating the structure of a microfluidic chip according to one or more embodiments of the present application.

FIG. 3 is a flowchart of a droplet driving method based on a microfluidic chip according to one or more embodiments of the present application.

FIG. 4 is a diagram illustrating the structure of a droplet path editing interface according to one or more embodiments of the present application.

FIG. 5 is a diagram illustrating the structure of another droplet path editing interface according to one or more embodiments of the present application.

FIG. 6 is a diagram illustrating the structure of still another droplet path editing interface according to one or more embodiments of the present application.

FIG. 7 is a diagram illustrating the structure of still another droplet path editing interface according to one or more embodiments of the present application.

FIG. 8 is a diagram illustrating the structure of still another droplet path editing interface according to one or more embodiments of the present application.

FIG. 9 is a diagram illustrating the structure of still another droplet path editing interface according to one or more embodiments of the present application.

FIG. 10 is a diagram illustrating the structure of still another droplet path editing interface according to one or more embodiments of the present application.

FIG. 11 is a flowchart of a driving signal control method according to one or more embodiments of the present application.

FIG. 12 is a diagram illustrating the structure of still another droplet path editing interface according to one or more embodiments of the present application.

FIG. 13 is a structural diagram of the extension process of a path selecting control according to one or more embodiments of the present application.

FIG. 14 is a top view of the structure of another microfluidic chip according to one or more embodiments of the present application.

FIG. 15 is a flowchart of a method for displaying moving path information according to one or more embodiments of the present application.

FIG. 16 is a diagram illustrating the structure of still another droplet path editing interface according to one or more embodiments of the present application.

FIG. 17 is a structural diagram of the display process of extension windows according to one or more embodiments of the present application.

FIG. 18 is a flowchart of another driving signal control method according to one or more embodiments of the present application.

FIG. 19 is a block diagram illustrating the structure of a droplet driving apparatus based on a microfluidic chip according to one or more embodiments of the present application.

FIG. 20 is a diagram illustrating the structure of an electronic device according to one or more embodiments of the present application.

### DETAILED DESCRIPTION

To make the objects, solutions, and advantages of the present application clearer, the solutions of the present application will be completely described below in conjunction with the specific embodiments and the drawings in the embodiments of the present application. Apparently, the embodiments described below are part, not all, of the embodiments of the present application. It is apparent for those skilled in the art that various modifications and variations may be made in the present application without departing from the spirit or scope of the present application. Accordingly, the present application is intended to cover modifications and variations of the present application that fall within the scope of the corresponding claims (the claimed technical solutions) and their equivalents.

In addition, the term “first”, “second”, and the like in the embodiments of the present disclosure are used to distinguish different components but not used to describe any order, quantity, or significance. Similarly, the term “one”, “a”, “the”, or the like does not mean a quantitative limit, but indicates the existence of at least one. The term “including”, “comprising”, or the like means that the elements or objects in front of the term cover elements or objects and their equivalents listed in the back of the term, but do not exclude other elements or objects. The term “connect”, “connected to”, or the like is not limited to physical or mechanical connections, but may include electrical connections, whether it is direct or indirect. “On”, “below”, “left”, “right”, and the like are only utilized to indicate the relative positional relationship, and when the absolute position of the described object is changed, the relative positional relationship may also change accordingly. In addition, the descriptions of being the same, equal, and the like involved in the embodiments of the present disclosure do not mean that two objects are completely equal in size and have exactly the same shape. The two objects are allowed to be approximately the same and approximately equal within a certain error range.

It is to be noted that embodiments of the present application, if not in collision, may be combined with each other.

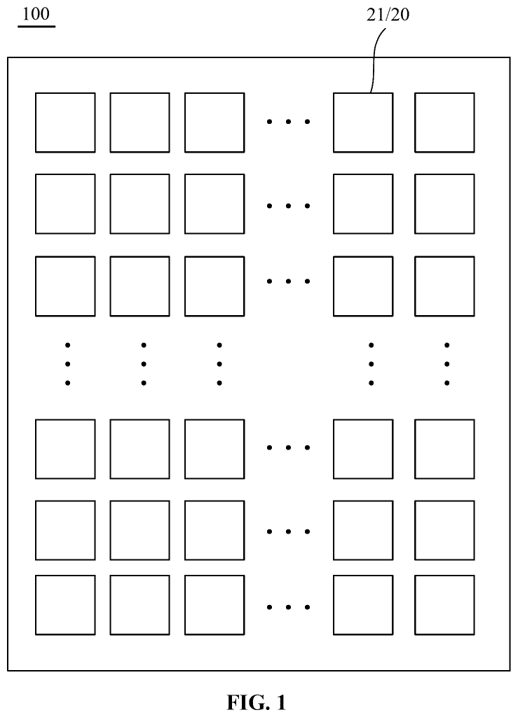

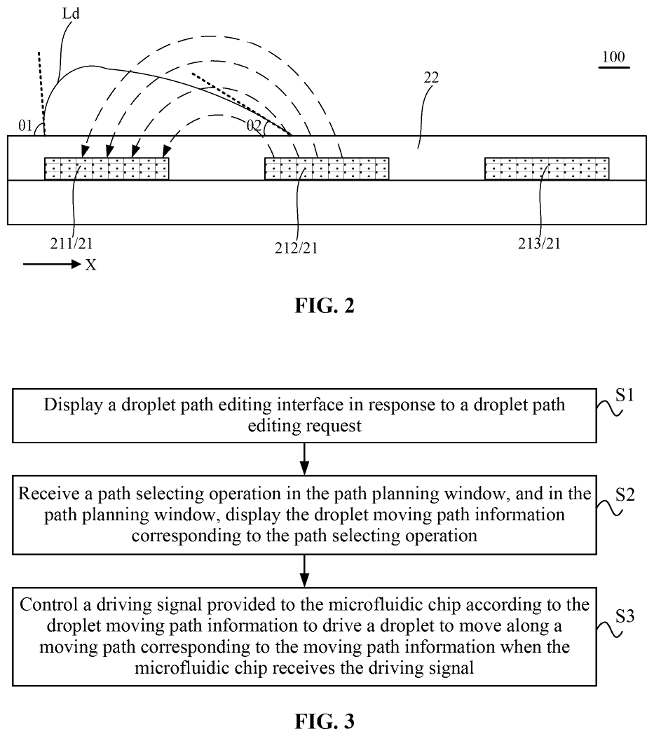

FIG. 1 is a top view of the structure of a microfluidic chip according to one or more embodiments of the present application. FIG. 2 is a sectional view illustrating the structure of a microfluidic chip according to one or more embodiments of the present application. With reference to FIG. 1 and FIG. 2, the microfluidic chip 100 includes a chip substrate and multiple driving units 20 disposed on the chip substrate; each of the driving units 20 may include a driving electrode 21. A corresponding driving voltage is applied to the driving electrode to form a driving electric field, so as to control a droplet Ld located in the driving electric field radiation region to move in a specific direction. Illustratively, for example, three adjacent driving electrodes arranged in a first direction X are a first driving electrode 211, a second driving electrode 212, and a third driving electrode 213, respectively. If the start position of the droplet Ld is disposed on an insulation layer 22 above the first driving electrode 211, a driving electric field through the droplet Ld can be formed when a driving voltage applied to the second driving electrode 212 is greater than a driving voltage applied to the first driving electrode 211. In this manner, the contact angle between the droplet Ld and the insulation layer 22 above the driving electrode 21 changes, that is, the contact angle between the droplet Ld adjacent to the second driving electrode 212 and the insulation layer 22 is relatively small, and the contact angle between the droplet Ld away from the second driving electrode 212 and the insulation layer 22 is relatively large. Due to the difference in contact angles, a voltage difference occurs inside the droplet Ld in the first direction X, driving the droplet Ld to move in the direction of the second driving electrode 212. Correspondingly, when the droplet Ld is on the insulation layer 22 above the second driving electrode 212, a larger driving voltage may be applied to the third driving electrode 213 while a smaller driving voltage may be applied to the second driving electrode 212 so that the contact angle between the droplet Ld adjacent to the third driving electrode 213 and the insulation layer 22 can be reduced, and the droplet Ld is driven to continue to move in a direction of the third driving electrode. In this manner, the droplet Ld can be driven to move in a specific direction by applying a corresponding driving voltage to the driving electrode 21.

Correspondingly, the driving unit 20 may also include a driver circuit electrically connected to the driving electrode 21 (not shown in the figures). The driver circuit of the driving unit may control the driving voltage provided to driving electrodes electrically connected to the driver circuit according to corresponding driving signals, so as to drive the droplet Ld to move in a set direction on the insulation layer above the driving electrode 21. Based on this, the driving signal provided to the driving unit 20 can control the moving path of the droplet Ld.

In the related art, the driving signal provided to the driving unit is generally provided by a driver chip. The driver program corresponding to the driving signal is burned into the driver chip so that when the driver program runs in the driver chip, the driver chip can correspondingly provide a driving signal to the driving unit. However, since the driver program burned into the driver chip has unique certainty, the driving signal output to the driving unit according to the driver program is relatively single, thus making the moving path of the droplet driven by the microfluidic chip relatively single and resulting in the inability to meet the needs of diverse movement routes. In addition, if the moving path of the droplet needs to be changed, the driver program needs to be modified, and the modified driver program needs to be re-burned into the driver chip. The operation process of this method is complicated, and multiple burnings affect the service life of the driver chip, thus virtually increasing the cost of the microfluidic chip.

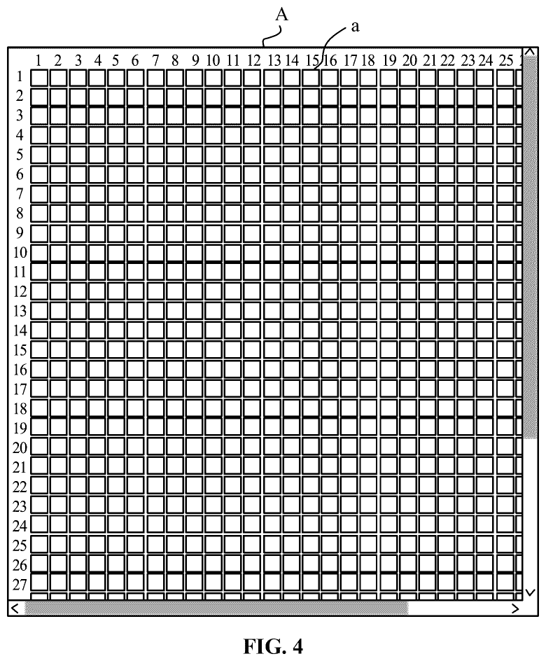

To resolve the preceding technical problem, embodiments of the present application provide a droplet driving method based on a microfluidic chip to solve the defects of the related technology and meet the needs of diverse movement routes of droplets. The method can drive a droplet to move in any path. The droplet driving method based on a microfluidic chip of the embodiments of the present application can drive the microfluidic chip provided by the embodiments of the present application and can be executed by a droplet driving apparatus based on a microfluidic chip according to the embodiments of the present application. The droplet driving apparatus based on a microfluidic chip may be implemented by software and/or hardware and may be integrated into a host computer. FIG. 3 is a flowchart of a droplet driving method based on a microfluidic chip according to one or more embodiments of the present application. As shown in FIG. 3, the droplet driving method based on a microfluidic chip includes the steps below.

In S1, a droplet path editing interface is displayed in response to a droplet path editing request.

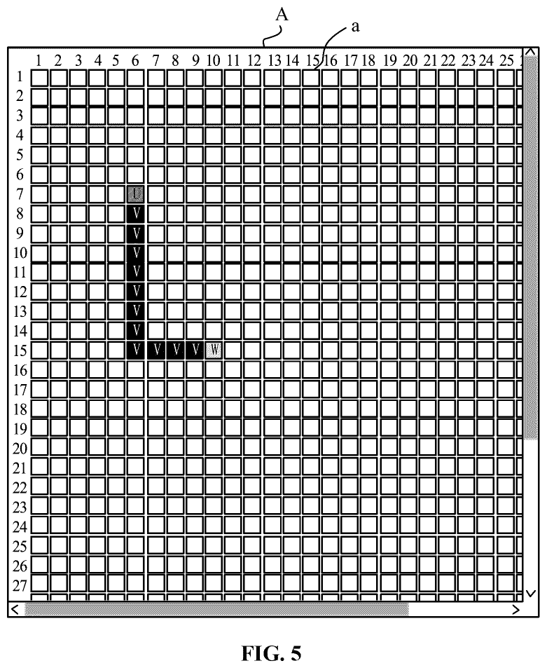

The droplet path editing request may be understood as an enabling request for initiating the droplet path editing function. The droplet path editing request may be sent by a user. For example, the droplet path editing request may be used to activate the display of a host computer for displaying the droplet path editing interface for the user or be used to start a relevant application icon in the display of the host computer so that the display of the host computer displays the droplet path editing interface. The droplet path editing interface at least includes a path planning window. Illustratively, as shown in FIG. 4, the path planning window A may include multiple path selecting controls a arranged in an array, and one path selecting control a may correspond to a driving electrode in the microfluidic substrate, or one path selecting control a may also correspond to the coverage area of the droplet in the microfluidic substrate, that is, the size of a path selecting control a may be equal to the size of the droplet. Special limitation is not made in this embodiment of the present application on the premise that core application points of embodiments of the present application can be implemented.

In S2, a path selecting operation in the path planning window is received, and in the path planning window, the droplet moving path information corresponding to the path selecting operation is displayed.

The path selecting operation may be understood as an operation related to setting the moving direction and the moving position of the droplet by the user in the path planning window. In optional embodiments, the path selecting operation at least includes a start position selecting operation, an intermediate position selecting operation, and an end position selecting operation.

In an example embodiment, an example is used where the path planning window includes multiple path selecting controls arranged in an array. The user's start position selecting operation in the path planning window may be selecting, from the path selecting controls in the path planning window by the user, a path selecting control representing a start position of the droplet moving path (for example, a path selecting control U shown as a box filled with dark gray in FIG. 5 represents a path selecting control U using a red mark). The user's intermediate position selecting operation in the path planning window may be selecting, from the path selecting controls in the path planning window by the user, a path selecting control representing an intermediate position of the droplet moving path (for example, a the path selecting control V shown as a box filled with black in FIG. 5 represents a path selecting control V using a green mark). The user's end position selecting operation in the path planning window may be selecting, from the path selecting controls in the path planning window by the user, a path selecting control representing an end position of the droplet moving path (for example, a path selecting control W shown as a box filled with light gray in FIG. 5 represents a path selecting control W using a yellow mark). In this manner, the user may separately set, in the path planning window, a start position, an intermediate position, and an end position that the droplet needs to pass during its movement process according to the needs of the actual droplet moving path. According to the needs of the actual size and the moving path of the droplet, one or more start positions, one or more intermediate positions, and one or more end positions may be provided. Correspondingly, one or more start position selecting operations, one or more intermediate position selecting operations, and one or more end position selecting operations may also be performed. Special limitation is not made in this embodiment of the present application.

It can be understood that the path selecting operation may include but is not limited to performing an operation on the path selecting control based on a selecting operation device such as a mouse or a keyboard connected to the display. For example, the path selecting operation may include but is not limited to clicking, double-clicking, left-clicking, or right-clicking the path selecting control based on the mouse to change the properties of the path selecting control. The start position selecting operation, the intermediate position selecting operation, and the end position selecting operation may be the same or different. In an example, both the start position selecting operation and the intermediate position selecting operation may be clicking the left button of the mouse or clicking the right button of the mouse to select the path selecting control at a corresponding position, and the end position selecting operation may be clicking the left button of the mouse or double-clicking the right button of the mouse to select the path selecting control at a corresponding position. In another example, the start position selecting operation may be double-clicking the left button of the mouse to select the path selecting control at the start position, the intermediate position selecting operation may be clicking the left button of the mouse to select the path selecting control at the intermediate position, and the end position selecting operation may be clicking the right button of the mouse to select the path selecting control at the end position. In another optional embodiment, when the display has a touch function, a corresponding path selecting operation may also be performed based on the user's finger or touch objects such as a stylus. Special limitation is not made in this embodiment of the present application on the premise that core application points of embodiments of the present application can be implemented.

It can also be understood that when the path selecting operation includes a start position selecting operation, an intermediate position selecting operation, and an end position selecting operation, the sequence of performing these position selecting operations may not be limited. In other words, a corresponding path selecting operation may be performed according to the arrival sequence in the droplet moving process, or a corresponding path selecting operation may be performed in any sequence according to the user's setting habit. That is, in optional embodiments, a start position selecting operation may be performed first, an intermediate position selecting operation is performed next, and an end position selecting operation is finally performed. In another optional embodiment, an intermediate position selecting operation may be performed first, and then a start position selecting operation and an end position selecting operation are sequentially performed. Special limitation is not made in this embodiment of the present application on the premise that core application points of embodiments of the present application can be implemented.

After the user's start position selecting operation, intermediate position selecting operation, and the end position selecting operation in the path planning window are received, the path planning window may display the selected path selecting controls in a display manner different from unselected path selecting controls to visually display the droplet moving path information, that is, the positions the droplet passes during the droplet's movement process are displayed for the user to view so that the user checks the selected path selecting controls. Thus, missed selections and incorrect selections are prevented.

It should be noted that after the path selecting control is selected, an operation such as selection canceling and selection clearing may be also performed so that when a selection canceling operation for the selected control is received, the selected path selecting control may be changed to an unselected path selecting control, or when a selection clearing operation in the path planning window is received, all selected path selecting controls in the path planning window may be changed to unselected path selecting controls so that the path planning window may set the droplet moving path information for unlimited times.

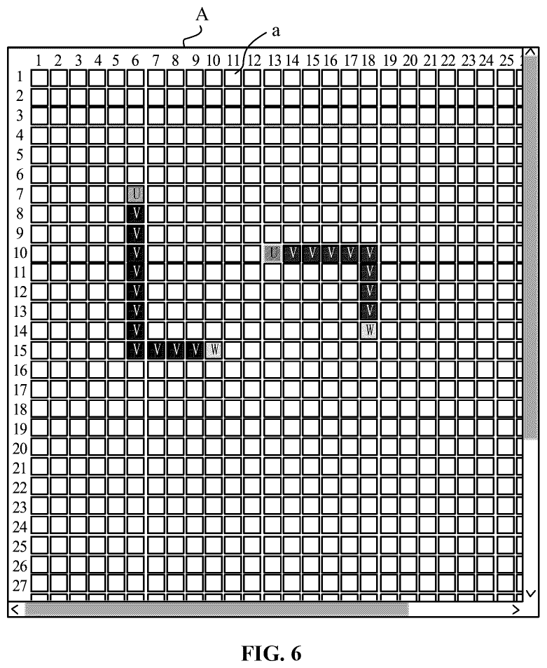

It can be understood that since one or more start positions, one or more intermediate positions, and one or more end positions may be provided, the droplet moving path information displayed in the path planning window may include one or more droplet moving paths. As shown in FIG. 5, the path planning window displays one droplet moving path, or as shown in FIG. 6, the path planning window displays two droplet moving paths. The specific display manner may be set according to actual needs.

It can also be understood that in FIG. 5 and FIG. 6, it is only exemplary that the path selecting control located at the start position, the path selecting control located at the intermediate position, and the path selecting control located at the end position are displayed in different colors. In another optional embodiment, path selecting controls in different positions may also be displayed in different shapes, or path selecting controls in different positions may be displayed in the same color. In addition, the display color and shape presented by the path selecting control may be set according to actual needs.

In optional embodiments, the droplet path editing interface also includes an identification window, and the identification window displays a start color identification, an intermediate color identification, and an end color identification corresponding to the start position selecting operation, the intermediate position selecting operation, and the end position selecting operation, respectively. In this case, when the start position selecting operation is received, the same color as the start color identification is displayed at a start position operation location of the path planning window; when the intermediate position selecting operation is received, the same color as the intermediate color identification is displayed at an intermediate position operation location of the path planning window; and when the end position selecting operation is received, the same color as the end color identification is displayed at an end position operation location of the path planning window.

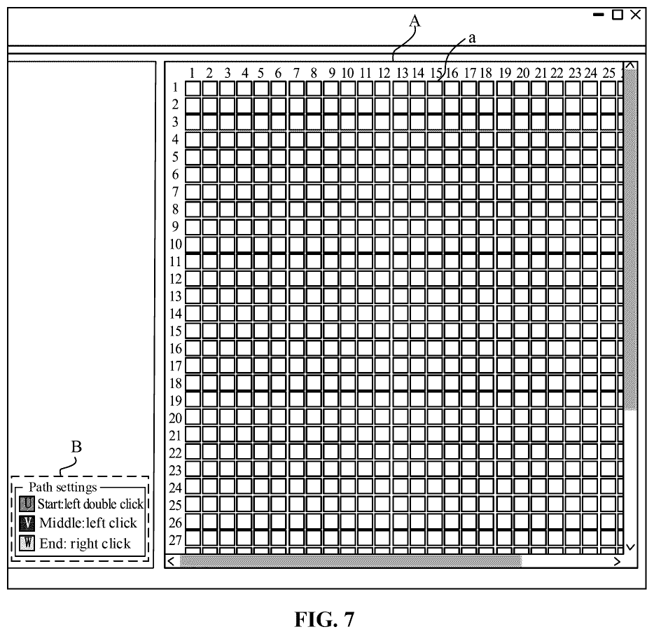

As a feasible embodiment, as shown in FIG. 7, the droplet path editing interface also includes an identification window B that may be disposed on a side of the path planning window A; the identification window B includes a start color identification, an intermediate color identification, and an end color identification that are of the same shape as the path selecting control a in the path planning window A, and colors of the start color identification, the intermediate color identification, and the end color identification are different; corresponding annotations may be disposed on the sides of the start color identification, the intermediate color identification, and the end color identification respectively. The annotations may be displayed in any language and may be displayed according to the language selected by the user so that the user distinguishes the meanings represented by the color identifications. In this case, when a start position selecting operation performed on the path selecting control U located at the start position of the droplet moving path in the path planning window A is received, the color of the path selecting control U at the start position may be changed to the same color as the start color identification; when an intermediate position selecting operation performed on the path selecting control V located at the intermediate position of the droplet moving path in the path planning window A is received, the color of the path selecting control V at the intermediate position may be changed to the same color as the intermediate color identification; and correspondingly, when the end position selecting operation performed on the path selecting control W located at the end position of the droplet moving path in the path planning window A is received, the color of the path selecting control W at the end position may be changed to the same color as the end color identification. In this manner, in the path planning window, path selecting controls at different positions of the droplet moving path are displayed in different colors so that the user can intuitively learn the start position, the intermediate position, and the end position of the droplet moving path and conveniently checks the selected positions to prevent missed selections and incorrect selections that may cause the droplet moving path to deviate. Thus, the accuracy and reliability of setting the droplet moving path are improved.

The start color identification, the intermediate color identification, and the end color identification may be arranged in a straight line in a direction parallel to the row direction or column direction of the path selecting control a. Alternatively, in another example embodiment, the start color identification, the intermediate color identification, and the end color identification may also be arranged in a delta shape. The embodiment of the present application does not limit the arrangement of the start color identification, the intermediate color identification, and the end color identification. The user may separately set the colors of the start color identification, the intermediate color identification, and the end color identification according to actual needs. Alternatively, the start color identification, the intermediate color identification, and the end color identification may be fixed identifications, which is not limited by the embodiment of the present application on the premise that different color identifications can be distinguished.

In S3, a driving signal for the microfluidic chip is controlled according to the droplet moving path information to drive a droplet to move along a moving path corresponding to the moving path information when the microfluidic chip receives the driving signal.

Illustratively, since the droplet moving path information includes information about the start position, the intermediate position, and the end position of the droplet moving path set by the user, the driving signals provided to the driving units in the microfluidic chip can be determined in a one-to-one correspondence based on the droplet moving path information so that the driving units in the microfluidic chip can control, based on the received driving signals, the magnitude of the driving voltages on driving electrodes of the driving units. Thus, a driving electric field generated between the driving electrodes can drive the droplet to sequentially pass, along the moving path set by the user, the start position and the intermediate position and arrive at the end position to facilitate the detection of the droplet.

In an example embodiment, with reference to FIG. 1 and FIG. 5, when the path selecting controls a in the path planning window A are in a one-to-one correspondence with the driving units 20 in the microfluidic chip 100, before the droplet reaches the driving electrode 21 in the driving unit 20 corresponding to the path selecting control U located at the start position, a driving signal provided to the microfluidic chip 100 may be controlled so that the driving voltage of the driving electrode 21 in the driving unit 20 corresponding to the path selecting control U located at the start position is higher than the driving voltages of other driving electrodes, and thus the droplet can smoothly reach the driving electrode 21 in the driving unit 20 corresponding to the path selecting control U located at the start position; when the droplet reaches the driving electrode 21 in the driving unit 20 corresponding to the path selecting control U at the start position, a driving signal provided to the microfluidic chip 100 may be controlled again so that the driving voltage of the driving electrode 21 in the driving unit 20 corresponding to the path selecting control V at the first intermediate position (that is, the path selecting control V adjacent to the path selecting control U) is higher than the driving voltages of other driving electrodes, and thus the droplet can smoothly reach the driving electrode in the driving unit 20 corresponding to the path selecting control V at the first intermediate position; and so on until the droplet reaches the path selecting control V at the last intermediate position (that is, the path selecting control V adjacent to the path selecting control W at the end position), a driving signal provided to the microfluidic chip 100 is controlled so that the driving voltage of the driving electrode 21 in the driving unit 20 corresponding to the path selecting control W at the end position is higher than the driving voltages of other driving electrodes, and thus the droplet can move to the driving electrode 21 of the driving unit corresponding to the path selecting control W at the end position. In this manner, the droplet can move along the moving path corresponding to the moving path information, thereby completing the driving of the droplet.

In embodiments of present application, a droplet path editing interface is displayed in response to a droplet path editing request so that a user can directly view the droplet path editing interface and conveniently perform a path selecting operation as required on the droplet path editing interface. Moreover, when a path selecting operation for a path planning window is received, the droplet moving path information corresponding to the path selecting operation is displayed in the path planning window so that the user can intuitively acquire the droplet moving path, and when subsequently controlling the microfluidic chip, the user can control a driving signal to the microfluidic chip according to the droplet moving path information displayed in the path planning window. Thus, when receiving the driving signal, the microfluidic chip can drive the droplet to move along a moving path corresponding to the moving path information set by the user. In this manner, the user only needs to perform a path selecting operation on the droplet path editing interface to implement the planning of any moving path of the droplet. The operation is simple without repeated programs burning, which helps save manpower and material costs and simplifies the driving method of any moving path of droplets. Thus, the detection efficiency is improved when the droplet is a detection droplet.

In optional embodiments, the droplet path editing interface may also include a menu bar and a communication display frame; in this case, the droplet driving method also includes receiving an array selecting operation in the menu bar, and displaying, in the path planning window, a path selecting control array corresponding to the array selecting operation; and/or receiving a communication selecting operation in the menu bar, displaying, in a communication display frame, a communication manner corresponding to the communication selecting operation, and determining, according to the communication manner, a sending path for sending the driving signal to the microfluidic chip.

The array selecting operation may be understood as an operation performed by the user to select, according to actual needs, a path selecting control array corresponding to a driving unit array in the microfluidic chip so that the arrangement of the path selecting control array displayed in the path planning window can be consistent with the arrangement of the driving unit in the microfluidic chip. The communication selecting operation may be understood as an operation performed by the user to select, according to actual needs, a communication manner in which the host computer communicates with the microfluidic chip so that the host computer can accurately send the driving signal to the microfluidic chip.

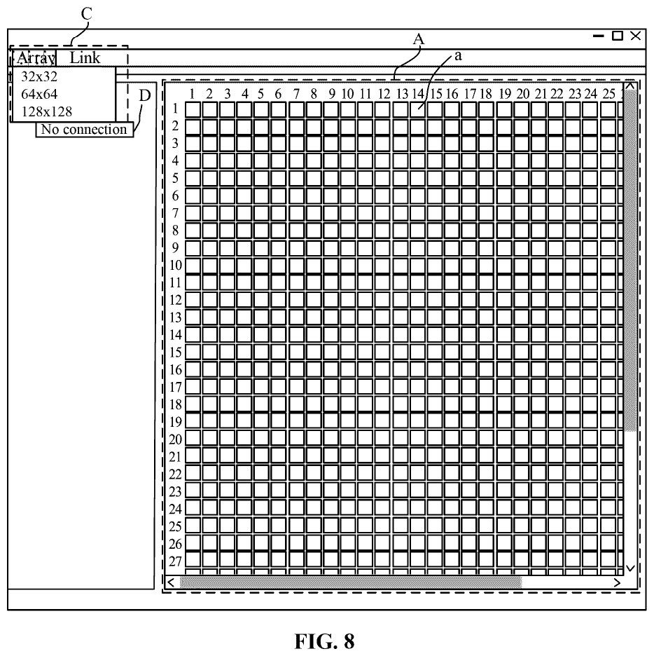

As a feasible embodiment, with reference to FIG. 8, both a menu bar C and a communication display frame D in the displayed droplet path editing interface may be on a side of the path planning window A, and the menu bar C may include an array selecting control Array. In this case, the user may perform an array selecting operation on the array selecting control Array. The array selecting operation may include, for example, clicking the array selecting control Array to display selectable array controls and further selecting a corresponding array control to meet different driving needs of the microfluidic chip. For example, when the driving unit in the microfluidic chip is arranged in a 32×32 array, the user may select a control array identified by 32×32 in the displayed array so that the path selecting controls a are presented in a 32×32 array in the path planning window A. Correspondingly, when the driving unit in the microfluidic chip is arranged in a 64×64 array, the user may select a control array identified by 64×64 in the displayed array so that the path selecting controls a are presented in a 64×64 array in the path planning window A. By analogy, a control array identified by 128×128 may be selected as required. The preceding arrays are only an example of the present application, and the specific number of arrays is not limited by the embodiment of the present application.

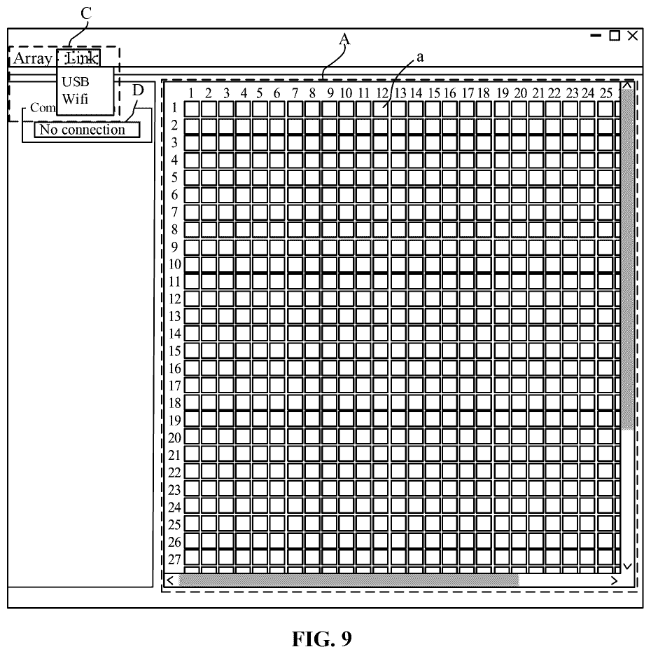

As shown in FIG. 9, the menu bar C may also include a communication selecting control Link. In this case, the user may perform a communication selecting operation on the communication selecting control Link. The communication selecting operation may include, for example, clicking the communication selecting control Link to display selectable communication controls and further clicking a corresponding communication control so that the host computer can perform information interaction with the microfluidic chip in the communication manner corresponding to the selected communication control. Illustratively, the communication control may include a USB communication control and a Wi-Fi communication control, which is not limited by the embodiment of the present application. When the communication control selected by the user is a USB communication control, the host computer and the microfluidic chip may interact with each other through a USB interface and a corresponding bus. When the communication control selected by the user is a Wi-Fi communication control, the host computer and the microfluidic chip may interact with each other through wireless transmission. The specific information interaction manner may be selected according to actual needs. Correspondingly, when the user does not perform any communication selecting operation, the communication display frame D may correspondingly present an identification indicating that the host computer and the microfluidic chip are not in a communication connection. After the user performs a communication selecting operation and determines the information interaction manner between the host computer and the microfluidic chip, if the host computer and the microfluidic chip are successfully connected, the communication display frame D may correspondingly present an identification indicating that the host computer and the microfluidic chip are in a communication connection, or the communication display frame D may correspondingly present an identification of the specific communication manner between the host computer and the microfluidic chip. In this manner, the user may intuitively acquire whether the host computer and the microfluidic chip are accurately connected to ensure that when a driving signal needs to be provided to the microfluidic chip, the host computer and the microfluidic chip can be in a normal connection state so that the driving signal can be accurately provided to the microfluidic chip, and thus the microfluidic chip can drive the droplet to move accurately along the droplet moving path set by the user.

Optionally, the droplet path editing interface may also include a parameter setting window. In this case, the droplet driving method may also include receiving a parameter setting operation in the parameter setting window and displaying, in the parameter setting window, the droplet parameter information corresponding to the parameter setting operation; where the droplet parameter information includes the size of the droplet.

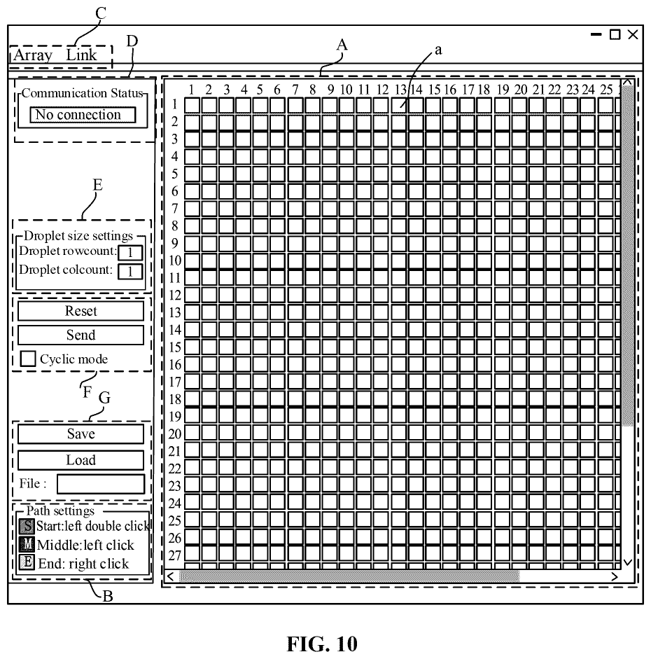

Illustratively, as shown in FIG. 10, the parameter setting window E in the droplet path editing interface is disposed on a side of the path planning window, and the parameter setting window E includes two edit frames. The two edit frames may separately receive a parameter setting operation of the horizontal size of the droplet and a parameter setting operation of the vertical size of the droplet so that the horizontal size of the droplet and the vertical size of the droplet are displayed in the two edit frames, respectively for viewing by the user. The horizontal size and the vertical size of the droplet may be set in units of the width and the length of the driving electrode of the microfluidic chip, respectively. For example, when the horizontal size of the droplet is 1 time the width of the driving electrode of the microfluidic chip, the number “1” may be displayed in the edit frame used to display the horizontal size of the droplet; when the vertical size of the droplet is twice the length of the driving electrode of the microfluidic chip, the number “2” may be displayed in the edit frame used to display the vertical size of the droplet. In this manner, the user may perform a corresponding parameter setting operation on the parameter setting window according to the actual size of the droplet.

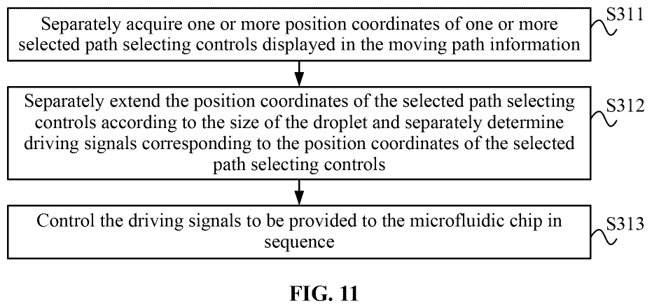

Optionally, when the path planning window includes multiple path selecting controls arranged in an array, and the path selecting operation includes an operation of selecting a path selecting control, the driving signal provided to the microfluidic chip is controlled correspondingly in combination with the position coordinates of one or more selected path selecting controls and the droplet size parameter set in the parameter setting window. As shown in FIG. 11, the specific implementation method for controlling a driving signal provided to the microfluidic chip includes the steps below.

In S311, the one or more position coordinates of one or more selected path selecting controls displayed in the moving path information are separately acquired.

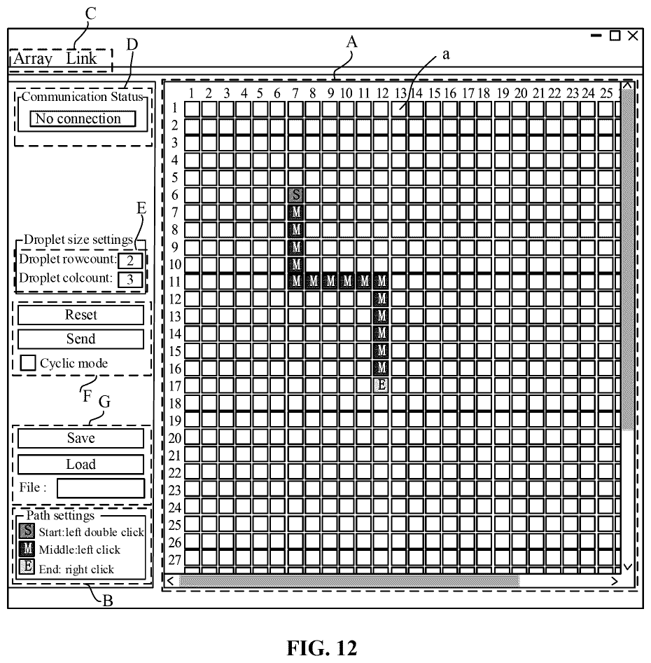

Illustratively, since the path selecting controls in the path planning window are arranged in an array, path selecting controls located in the same row are in different columns, and path selecting controls located in the same column are in different rows. In this case, the row and column in which a path selecting control is located may be used as the row coordinate and the column coordinate of the path selecting control, respectively, and the row coordinate and the column coordinate may constitute the position coordinate of the path selecting control. When performing a path selecting operation in the path planning window, the user may select one or more corresponding path selecting controls to form a droplet moving path according to actual needs, and the path selecting control included in the droplet moving path is displayed in a specific color in the path planning window. In this case, the position coordinate of the selected path selecting control may be determined by the row and column where the path selecting control is located. Illustratively, as shown in FIG. 12, a path selecting control at the start position in the droplet path is located in the sixth row and the seventh column. Therefore, the position coordinate of the path selecting control at the start position may be determined as (6, 7), and a path selecting control at the first intermediate position adjacent to the path selecting control at the start position is located in the seventh row and the seventh column. Thus, the position coordinate of the path selecting control at the first intermediate position may be determined as (7, 7). By analogy, the position coordinates of path selecting controls at other intermediate positions and a path selecting control at the end position can be determined.

It can be understood that the manner of acquiring the position coordinate of a selected path selecting control may include but is not limited to acquiring position coordinate in the process of selecting a path selecting control. This process is a real-time acquisition process, where a corresponding cache control does not need to be configured to save the position coordinate of the path selecting control. Alternatively, after completing the selecting of all the one or more path selecting controls, the position coordinates of the path selecting controls are simultaneously acquired. The manner of acquiring the position coordinates of selected path selecting controls is not limited by the embodiment of the present application.

In optional embodiments, if the position coordinates of the selected path selecting controls are simultaneously acquired after path selecting controls are selected, the droplet driving method may also include when a path selecting operation in the path planning window is received, sequentially saving the position coordinates of the one or more selected path selecting controls in an SS queue according to the selection sequence of the one or more path selecting controls.

The SS queue is usually a first-in-first-out queue, that is, data first saved in the SS queue is also first read in a reading process. When the user performs a path selecting operation in the path planning window, the position coordinates of one or more selected path selecting controls may be saved in the SS queue according to the selection sequence of the user. For example, the position coordinate of a path selecting control at the start position, the position coordinate of a path selecting control at the intermediate position, and the position coordinate of a path selecting control at the end position may be sequentially saved in the SS queue, so as to facilitate subsequent calls.

Optionally, separately acquiring the position coordinates of the one or more selected path selecting controls displayed in the moving path information may include sequentially extracting, from the SS queue, an element located at a head position of the SS queue and determining, according to the extracted element located at the head position of the SS queue, the position coordinate of the selected path selecting control.

When the one or more selected path selecting controls are saved in the SS queue, and when the position coordinates of the one or more selected path selecting controls are acquired, the position coordinates of the selected path selecting controls need to be extracted from the SS queue, and based on the first-in-first-out principle of the SS queue, the position coordinate first saved in the SS queue is first extracted. For example, the position coordinate of a path selecting control at the start position, the position coordinate of a path selecting control at the intermediate position, and the position coordinate of a path selecting control at the end position are sequentially extracted from the SS queue.

In an example embodiment, as shown in FIG. 12, the position coordinate of the path selecting control at the start position in the droplet moving path is (6, 7), the position coordinate of the path selecting control at the first intermediate position adjacent to the path selecting control at the start position is (7, 7), and the position coordinate of the path selecting control at the second intermediate position adjacent to the path selecting control at the first intermediate position is (8, 7), . . . the position coordinate of the path selecting control at the fifteenth intermediate position is (16, 12), and the position coordinate of the path selecting control at the end position is (17, 12). When a path selecting operation is performed, the path selecting control at the start position may be first selected, and the position coordinate (6, 7) of the path selecting control at the start position is saved in the SS queue; the path selecting control at the first intermediate position is selected, and the position coordinate (7, 7) of the path selecting control at the first intermediate position is saved in the SS queue; the path selecting control at the second intermediate position is then selected, and the position coordinate (8, 7) of the path selecting control at the second intermediate position is saved in the SS queue, . . . until the fifteenth intermediate position coordinate (16, 12) is saved in the SS queue; the path selecting control at the end position is finally selected, and the position coordinate (17, 12) of the path selecting control at the end position is saved in the SS queue. In this case, the SS queue saves the position coordinates of 17 path selecting controls from the start position to the end position. Before the driving signal is provided to the microfluidic chip, the position coordinates of the path selecting controls saved in the SS queue need to be extracted. In this case, the position coordinate at a head position in the SS queue may be first extracted, that is, the position coordinate (6,7) is first extracted; at this time, it may be determined that the position coordinate of the path selecting control at the start position is (6,7). After the position coordinate (6, 7) is extracted, the position coordinate (7, 7) becomes the position coordinate at the head position in the SS queue; in this case, the position coordinate (7, 7) may be extracted, and the position coordinate of the path selecting control at the first intermediate position may be determined. After the position coordinate (7, 7) is extracted, the position coordinate (8, 7) becomes the position coordinate in the head position in the SS queue; in this case, the position coordinate (8, 7) may be extracted, and the position coordinate of the path selecting control at the second intermediate position may be determined; after the position coordinate (16,12) is extracted, the position coordinate (17, 12) becomes the position coordinate in the head position in the SS queue; in this case, the position coordinate (17, 12) may be extracted, and the position coordinate of the path selecting control at the first intermediate position may be determined. In this manner, the position coordinates of the selected path selecting controls are sequentially saved in the SS queue in the selection sequence so that when the position coordinates of the selected path selecting controls need to be used, the position coordinates of the selected path selecting controls can be sequentially extracted in the saving sequence, thereby facilitating the simplification of the saving and calling manner and improving the selection and calling efficiency of the path selecting controls.

In S312, the one or more position coordinates of the one or more selected path selecting controls are separately extended according to the size of the droplet, and one or more driving signals corresponding to the position coordinates of the one or more selected selecting controls are separately determined.

The size of the droplet is the number of driving electrodes that the droplet can cover. The size of the droplet may be greater than the size of one driving electrode. In this case, the horizontal size and/or the vertical size of the droplet set in the parameter setting window are greater than 1. If the driving signal provided to the microfluidic chip is determined according to the position coordinate of the currently selected path selecting control, one part of the droplet moves normally along the droplet moving path, while the other part of the droplet stays still. This causes the separation of the droplet, making it impossible to ensure the integrity of the droplet. Moreover, the subsequent detection is not facilitated.

In this embodiment, when the driving electrodes in the microfluidic chip are in a one-to-one correspondence with the path selecting controls in the path planning window, the size of a selected path selecting control that needs to be extended can be learned from the size of the droplet set in the parameter setting window, the selected path selecting controls are extended separately according to the size of the droplet, and the driving signal provided to the microfluidic chip is correspondingly determined based on the extended path selecting control. In this manner, the number of selected path selecting controls included in the droplet moving path information displayed based on the path selecting operation is the number of steps of the droplet movement. Each of the selected path selecting controls is extended according to the size of the droplet, and a corresponding driving signal is generated based on the extended selected path selecting controls so that when the microfluidic chip drives the droplet to move based on the driving signal, it is ensured that the droplet moves in a complete state from the start position to the end position via the intermediate position, thereby facilitating the subsequent detection of the droplet.

Optionally, the one or more selected path selecting controls include a first path selecting control, a second path selecting control, . . . and an N-th path selecting control corresponding to a start position, one or more intermediate positions, and an end position of the droplet; where Nis a positive integer greater than or equal to 3. In this case, extending the position coordinate of the selected path selecting control according to the size of the droplet and determining the driving signal corresponding to the position coordinate of the selected path selection include: traversing one or more path selecting controls in a row direction and/or a column direction of an i-th path selecting control according to the size of the droplet by starting at the position coordinate of the i-th path selecting control until the number of traversed path selecting controls in the row direction and/or column direction is equal to the size of the droplet in the row direction and/or column direction; and generating an i-th frame driving signal provided to the microfluidic chip according to the position coordinates of the traversed path selecting controls; where i is a positive integer greater than or equal to 1 and less than or equal to N.

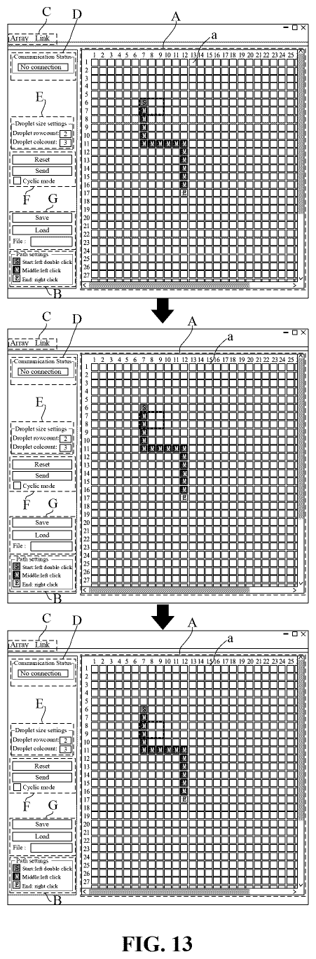

Illustratively, as shown in FIG. 13, the first path selecting control is a path selecting control at a start position, and the position coordinate of the first path selecting control is (6, 7). If the horizontal size of the droplet set in the parameter setting window is 3 and the vertical size is 2, traversing may be first performed in a row direction by taking the position coordinate (6, 7) of the first path selecting control as the starting point, and traversing is stopped when the number of traversed path selecting controls is equal to 3. In this case, the first path selecting control may be extended to three first path selecting controls whose position coordinates are (6, 7), (6, 8), and (6, 9), respectively. After the first path selecting control is extended in the row direction, the first path selecting control also needs to be extended in the column direction. In this case, traversing is performed in the column direction using the position coordinates of the three extended first path selecting controls in the row direction as the starting points until the number of path selecting controls traversed using the extended first path selecting control as the starting point is equal to 2. In this case, a first path selecting control may be extended to two path selecting controls, that is, the first path selecting control whose position coordinate is (6, 7) may be extended to two first path selecting controls whose position coordinates are (6, 7) and (7, 7), respectively, the first path selecting control whose position coordinate is (6, 8) may be extended to two first path selecting controls whose position coordinates are (6, 8) and (7, 8), respectively, and the first path selecting control whose position coordinate is (6, 9) may be extended to two first path selecting controls whose position coordinates are (6, 9) and (7, 9), respectively. In this manner, one first path selecting control may be extended to six first path selecting controls. Based on the position coordinates of the six first path selecting controls, a first frame driving signal corresponding to the first path selecting controls may be correspondingly generated. When the microfluidic chip receives the first frame driving signal, the driving voltages on the driving electrodes whose position coordinates are (6, 7), (7, 7), (6, 8), (7, 8), (6, 9), and (7, 9) can be controlled to be relatively high, while the voltages on other driving electrodes are controlled to be relatively low. Thus, the microfluidic chip can drive the droplet to move to cover the driving electrodes corresponding to the first path selecting controls. The generation manners of the second frame driving signal, the third frame driving signal, . . . and the N-th frame driving signal are all similar to the generation manner of the first frame driving signal. For similarities, reference is made to the preceding description, and details are not repeated herein.

It can be understood that the above is only an exemplary description of the extension manner of a selected path selecting control. The embodiment of the present application is not limited to the preceding traversing first in the row direction and then in the column direction. It is also possible to traverse in the column direction first, and then traverse in the row direction starting from the path selecting control traversed in the column direction. Alternatively, traversing may also be performed simultaneously in the column direction and row direction. The embodiment of the present application does not limit the sequence of traversing in the row direction and column direction on the premise that after the selected path selecting control is extended, the number of selected path selecting controls can be equal to the size of the droplet.

It can also be understood that the frame driving signal includes driving signals in a one-to-one correspondence with driving units in the microfluidic chip so that after a frame driving signal is provided to the microfluidic signal, the driving voltage on the driving electrode in the driving unit in the microfluidic chip can be refreshed once to drive the droplet one step forward. In addition, since driving the movement of the droplet relies on the driving electric field formed between adjacent driving electrodes, corresponding driving signals are provided to the driving units in a one-to-one correspondence so that the driving voltage of the driving electrode adjacent to the driving electrode currently covered by the droplet and located in the forward direction of the droplet is a higher voltage while the driving voltage on the driving electrode currently covered by the droplet is a lower voltage. In this manner, it is ensured that a driving electric field is generated between the driving electrode currently covered by the droplet and the driving electrode in the forward direction. Therefore, the driving signals corresponding to the driving units need to be determined in a one-to-one correspondence before a frame driving signal is provided to the microfluidic chip. The manner of determining driving signals corresponding to driving units may be set according to actual needs.

Optionally, generating the i-th frame driving signal provided to the microfluidic chip according to the position coordinates of the traversed path selecting controls includes: setting a storage value of each storage unit of storage units in a frame data buffer to a first storage value, where the position coordinate of the traversed path selecting control includes a row coordinate and a column coordinate; separately acquiring the position coordinates of the traversed path selecting controls in the row direction of the i-th path selecting control when traversing is performed in the row direction of the i-th path selecting control; searching, according to the position coordinates of the traversed path selecting controls in the row direction of the i-th path selecting control, the position coordinates of storage units in the frame data buffer corresponding to the position coordinates of the traversed path selecting controls in the row direction of the i-th path selecting control and determining the position coordinate of the corresponding storage units in the frame data buffer as the position coordinates of first storage units; modifying the storage value of each of the first storage units to a second storage value, where the second storage value is not equal to the first storage value; and sequentially modifying a storage value of each of another storage units in a column direction of each of the first storage units to the second storage value, until in a column direction of each of the first storage units, the number of storage units whose storage value is the second storage value is equal to the size of the droplet in the column direction.

The position coordinates of the storage units in the frame data buffer are in a one-to-one correspondence with the position coordinates of the path selecting controls in the path planning window. For example, when path selecting controls in the path planning window are arranged in a 128*128 array, the frame data buffer also has storage units arranged in a 128*128 array, and the storage unit may store one bit or more bits of data. The first storage value and the second storage value are different. For example, the first storage value may be “0”, and the second storage value may be “1” so that the first storage value and the second storage value may occupy one storage unit. In this case, just one bit of storage space for a storage unit in the frame data buffer is needed, which helps save cache space in the frame data buffer, improve the data processing speed, and reduce overall costs.

Illustratively, the droplet moving path information shown in FIG. 13 is used as an example. When the first frame driving signal needs to be generated, the storage values of storage units in the frame data buffer may be first assigned to a first storage value. When traversing is performed in the row direction with a first path selecting control as the starting point, the position coordinates of traversed path selecting controls may be sequentially acquired, and the storage values of the storage units corresponding to the position coordinates of the traversed path selecting controls are modified from the first storage value to a second storage value. For example, when traversing is performed with the first path selecting control whose position coordinate is (6, 7) as the starting point, the path selecting controls whose position coordinates of are (6, 7), (6, 8), and (6, 9) are traversed in sequence. When the path selecting control with the position coordinate (6, 7) is traversed, the storage unit with the position coordinate (6, 7) may be determined as a first storage unit, and the storage value of the first storage unit is modified from the first storage value to the second storage value. When the path selecting control with the position coordinate (6, 8) is traversed, the storage unit with the position coordinate (6, 8) may be determined as a first storage unit, and the storage value of the first storage unit is modified from the first storage value to the second storage value. When the path selecting control with the position coordinate (6, 9) is traversed, the storage unit with the position coordinate (6, 9) may be determined as a first storage unit, and the storage value of the first storage unit is modified from the first storage value to the second storage value. When the stored value of the first storage unit is modified, the number of rows of driving electrodes covered by the droplet may be determined according to the size of the droplet in the column direction of the driving electrodes. In this case, starting from the row where the first storage unit is located, the stored value of the first storage unit is first modified, and then the storage value in the next row adjacent to the row where the first storage unit is located and in the same column as the first storage unit is modified. Until the number of rows of the modified storage units is equal to the number of rows of the driving electrodes covered by the droplet, modifying the storage units is stopped so that the storage values of the modified storage units are the same. For example, when the vertical size of the droplet is 2 and the row where the first storage unit is located is the sixth row, the storage value of the storage unit in the seventh row that belongs to the same column as the first storage unit in the sixth row may be modified to the second storage value after the storage value of the first storage unit located on the sixth row is modified to the second storage value, while the storage values of other storage units in the same column remain the first storage value. In this case, the storage value of the storage unit in the first column of the seventh row is equal to the storage value of the storage unit in the first column of the sixth row, and the storage value of the storage unit in the second column of the seventh row is equal to the storage value in the second column of the sixth row, . . . the storage value of the storage unit in the seventh column of the seventh row is equal to the storage value of the storage unit in the seventh column of the sixth row. By analogy, the storage value of the storage unit in the seventh row can be directly modified without traversing the storage unit in the seventh row. In this manner, the data processing process can be simplified, which is beneficial to improving the data processing efficiency and enhancing the driving efficiency of the microfluidic chip.

It can be understood that data stored in a storage unit in the frame data buffer may generate a corresponding a storage-unit array in the form of bytes. An element in the storage-unit array may be one byte to store data, and the byte is equal to eight bits. After a storage unit corresponding to the position coordinate of a selected control is determined, elements in the array may be cyclically assigned in sequence so that the storage value at a first storage unit is changed to a second storage value. In addition, when an array element can store data of one byte, the array may include the storage values of eight bits located in the same row and adjacent to each other. For example, the storage values of the eight bits in the first to eighth columns in the first row are stored in the first array element of the first array, and the storage values of the bits in the ninth to sixteenth columns in the first row may be stored in the second array element of the first array. By analogy, the number of arrays may be n/8, where n is the number of path selecting controls in the path planning window.

In S313, the one or more driving signals are controlled to be provided to the microfluidic chip in sequence.

Illustratively, after the driving signals corresponding to the position coordinates of the selected path selecting controls are determined, the driving signals need to be provided to the microfluidic chip so that the driving units in the microfluidic chip can control the voltages on their driving electrodes according to the driving signals received by the driving units. Thus, a driving electric field is formed to drive the droplet to move along the moving path information displayed in the path planning window.

When the driving signal includes multiple frame driving signals in a one-to-one correspondence with the path selecting controls selected by the user, the frame driving signals may be provided to the microfluidic chip in the forward direction according to the positions of the selected path selecting controls in the droplet moving path. For example, the first frame driving signal corresponding to the path selecting control at the start position, that is, a first path selecting control, can be provided to the microfluidic chip first so that the microfluidic chip controls, according to the first frame driving signal, the driving voltage of the driving electrode. Thus, the droplet can move to the start position of the droplet moving path. After the droplet arrives at the start position of the droplet moving path, the microfluidic chip may feed back a corresponding moving signal to the host computer so that after the host computer receives the moving signal, and the second frame driving signal corresponding to a second path selecting control can be provided to the microfluidic chip. Thus, the microfluidic chip controls, according to the second frame driving signal, the driving voltage of the driving electrode, and the droplet can move to the first intermediate position of the droplet moving path; . . . after the droplet arrives at the last intermediate position, the microfluidic chip may feed back a corresponding moving signal to the host computer so that after receiving the moving signal, the host computer may provide an N-th frame driving signal corresponding to the N-th path selecting control to the microfluidic chip. Thus, the microfluidic chip controls the driving voltage of the driving electrode according to the N-th frame driving signal, and the droplet can move to the end position of the droplet moving path. In this manner, the frame driving signals are sequentially provided to the microfluidic chip so that the microfluidic chip drives the droplet to move along the droplet moving path set by the user, thereby meeting the demand for any moving path of the droplet and helping broaden the application scenarios of microfluidic chip. In addition, the frame driving signals are sequentially provided to the microfluidic chip so that the microfluidic chip receives the driving signals in frame-pair units, and a large storage space is not required in the microfluidic chip, which helps reduce the cost of the microfluidic chip.

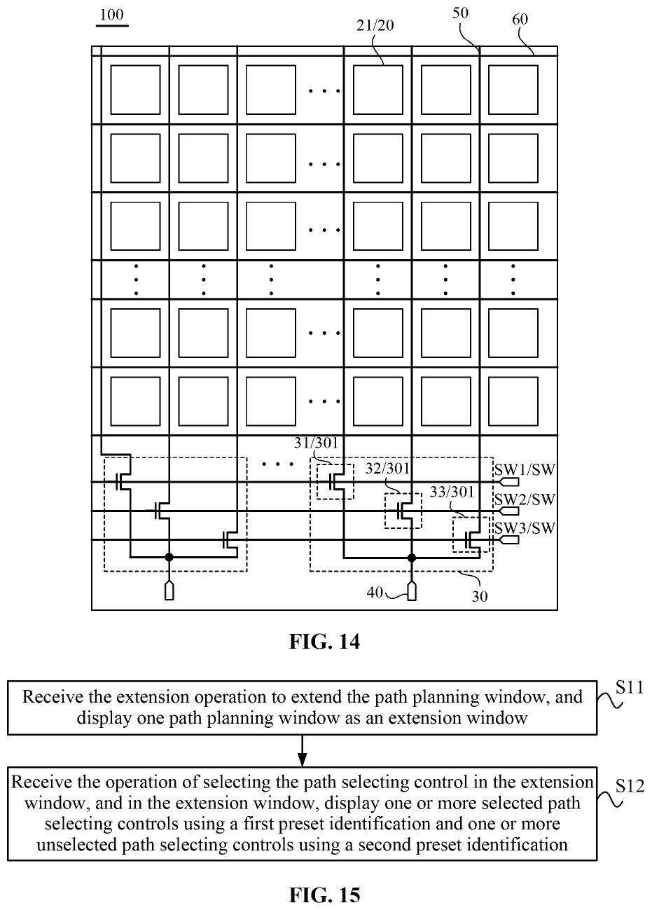

Optionally, as shown in FIG. 14, the microfluidic chip 100 includes multiple driving signal terminals 40, multiple multiplex selection circuits 30, and multiple driving signal lines 50; and a multiplex selection circuit 30 includes multiple switches 301; an output terminal of a switch 301 is electrically connected to a driving signal line 50; in the same multiplex selection circuit 30, input terminals of the switches 301 are electrically connected to a same driving signal terminal 40, and control terminals of the switches 301 are configured to receive different switch control signals SW; switch control signals SW are configured to control the time-sharing turn-on of the switches in the same multiplex selection circuit.

The switch may include a component such as a transistor. When the transistor in the switch is a P-type transistor, a high-level switch control signal may turn off the switch, and a low-level switch control signal may turn on the switch. When the transistor in the switch is a N-type transistor, a high-level switch control signal may turn on the switch, and a low-level switch control signal may turn off the switch. In this manner, the level of the switch control signal can be adaptively adjusted according to the type of transistor in the switch, thereby achieving the control of the switch. For ease of description, an example is used where the level of the switch control signal that controls the switch to be turned on is an enable level, and the level of the switch control signal that controls the switch to be turned off is a non-enable level, so as to explain the technical solutions of the embodiments of the present application.

It should be noted that the technical solutions of the embodiments of the present application are exemplarily described above by using an example where a multiplex selection circuit includes three switches. In the embodiments of the present application, the number of switches in a multiplex circuit may also be 2, 4, or more than 4.

When a multiplex selection circuit is disposed in the microfluidic chip, the driving units disposed in the same row receive driving signals at different moments. In this case, if a driving signal includes multiple frame driving signals, a frame driving signal may include multiple subframes in a one-to-one correspondence with switches in the multiplex selection circuit. Correspondingly, controlling the driving signal provided to the microfluidic chip may include sequentially providing, in the sequence in which the switches are turned on, a subframe corresponding to a currently turned-on switch to the microfluidic chip.

Illustratively, FIG. 14 is used as an example. The driving units disposed in the same column are electrically connected to the same driving signal line 50. The microfluidic chip 100 may also include a scan line 60. Driving units disposed in the same row may be electrically connected to the same scan line. Enable levels of scan signals are sequentially provided to the scan lines so that the driving signals transmitted by the driving signal lines can be provided to the driving units in a one-to-one correspondence. A multiplex selection circuit 30 includes a first switch 31, a second switch 32, and a third switch 33. The first switch 31, the second switch 32, and the third switch 33 are turned on in a time-sharing manner. For example, when the switch control signal SW1 controls the first switch 31 to be turned on, the switch control signal SW2 controls the second switch 32 to be turned off, and the switch control signal SW3 controls the third switch 33 to be turned off. When the switch control signal SW2 controls the second switch 32 to be turned on, the switch control signal SW1 controls the first switch 31 to be turned off, and the switch control signal SW3 controls the third switch 33 to be turned off. When the switch control signal SW3 controls the third switch 33 to be turned on, the switch control signal SW1 controls the first switch 31 to be turned off, and the switch control signal SW2 controls the second switch 32 to be turned off. In this case, a frame driving signal may include three subframes. The first subframe includes a driving signal for a driving unit electrically connected to the first switch 31. The second subframe includes a driving signal for a driving unit electrically connected to the second switch 32. The third sub-frame data includes a driving signal for a driving unit electrically connected to the third switch 33. Correspondingly, when the first switch 31 is turned on, the first subframe is provided to the microfluidic chip so that the driving units electrically connected to the first switch 31 can receive the driving signals in a one-to-one correspondence. When the second switch 32 is turned on, the second subframe is provided to the microfluidic chip so that the driving units electrically connected to the second switch 32 can receive the driving signals in a one-to-one correspondence. When the third open 33 is turned on, the third subframe is provided to the microfluidic chip so that the driving units electrically connected to the third switch 33 can receive the driving signals in a one-to-one correspondence. In this manner, the signals written into the driving units can be more accurate, and the accuracy and reliability of driving the droplet by the microfluidic chip can be improved.

In this embodiment, a multiplex selection circuit is disposed in the microfluidic chip, which helps reduce the number of driving signal terminals disposed in the microfluidic chip, thereby helping reduce the cost of the microfluidic chip. In addition, when a multiplex selection circuit is disposed in the microfluidic chip, the driving signal provided to the microfluidic chip may be determined according to the switch turn-on sequence in the multiplex selection circuit. In this manner, the data processing amount of the microfluidic chip can be reduced, and the driving efficiency of the microfluidic chip can be improved.

It can be understood that when a path selecting operation is performed on the path planning window, the number of selected path selecting controls represents the number of moving steps of the droplet so that one path planning window may display a complete droplet moving path for the user to view. In the embodiments of the present application, the manner in which the path planning window displays the droplet moving path information is not limited thereto, and in other embodiments of the present application, the number of path selecting controls selected by the path selecting operation does not necessarily represent the number of moving steps of the droplet. No special limitation is imposed herein on the premise that the technical solutions of the embodiments of the present application can be implemented.

Optionally, based on the preceding embodiments, the path planning window includes multiple path selecting controls arranged in an array, and the path selecting operation includes an extension operation to extend the path planning window and an operation of selecting a path selecting control. In this case, before a path selecting operation is performed, the path planning window is first extended, and then the path selecting operation is performed in the extended path planning window. As shown in FIG. 15, receiving the path selecting operation in the path planning window and displaying the droplet moving path information corresponding to the path selecting operation in the path planning window include the steps below.

In S11, the extension operation to extend the path planning window is received, and one path planning window is displayed as an extension window.

The extension operation may be understood as the operation of starting a new path planning window in the droplet path editing interface. The extension operation may include the following: The user inputs a corresponding path planning window extension signal through touch or an external input device so that after the host computer receives the path planning window extension signal, the host computer controls the droplet path editing interface to display a new path planning window. The new path planning window may cover the original path planning window; alternatively, when the new path planning window is displayed, the original path planning window may be automatically minimized; alternatively, the displayed new path planning window and the original path planning window may be arranged in a set manner. The embodiments of the present application do not limit the display manner of the path planning window.

Illustratively, after the path editing request is received and the droplet path editing interface is displayed, if no path planning window that can be displayed in the droplet path editing interface exists, an extension operation to extend the path planning window may be performed so that a first path planning window may be displayed in the droplet path editing interface as a first extension window, and thus, the user can perform a path selecting operation in the first extension window; if one path planning window cannot complete the setting of the droplet moving path information, the extension operation to extend the path planning window may be continued so that another new path planning window may be displayed in the droplet editing interface as a second extension window. Thus, the user can continue to perform the path selecting operation in the second extension window until all the droplet moving path settings are completed, then the extension operation and the path selecting operation may be stopped. In the embodiments of the present application, the number of extension windows that can be displayed in the droplet editing interface may be set according to actual needs. For example, in optional embodiments, the upper limit of the number of extension windows that can be displayed in the droplet editing interface may be 100. In other optional embodiments, the upper limit of the number may also be 200 or unlimited.

S12, the operation of selecting the path selecting control in the extension window is received, and in the extension window, one or more selected path selecting controls are displayed using a first preset identification, and one or more unselected path selecting controls are displayed using a second preset identification.

After the extension window is displayed in the droplet editing path, the extension window may include multiple path selecting controls arranged in an array. In this case, the user may perform a path selecting operation to select path selecting controls according to actual needs, that is, the user may perform an operation of selecting path selecting controls. In this case, one or more selected path selecting controls are displayed using a first preset identification, and one or more unselected path selecting controls are displayed using a second preset identification. The first preset identification and the second preset identification are different identifications. For example, the first preset identification and the second preset identification have different colors and/or shapes. In an example embodiment, the first preset identification may be green, and the second preset identification may be white. Correspondingly, the droplet moving path information may include the selected path selecting controls separately displayed in the extension window.

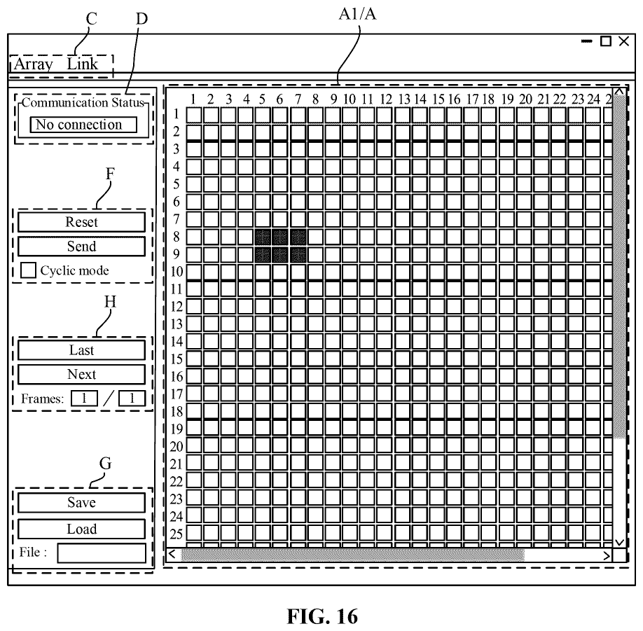

Illustratively, as shown in FIG. 16, for example, the path planning window displayed in the droplet path editing interface is a first extension window, if the user performs a path selecting operation in the first extension window, three path selecting controls that are located in the eighth row and the fifth column, located in the eighth row and the sixth column, and are located in the eighth row and the seventh column, respectively as well as three path selecting controls that are located in the ninth row and the fifth column, located in the ninth row and the sixth column, and are located in the ninth row and the seventh column, respectively are selected. In this case, the three path selecting controls that are located in the eighth row and the fifth column, located in the eighth row and the sixth column, and are located in the eighth row and the seventh column, respectively as well as the three path selecting controls that are located in the ninth row and the fifth column, located in the ninth row and the sixth column, and are located in the ninth row and the seventh column, respectively are adjusted to green, while other unselected path selecting controls remain white. In this manner, the user can directly view the positions of the selected path selecting controls and can conveniently check, review, and modify the selected path selecting controls. Thus, operations like missed selections and incorrect selections of path selecting controls can be prevented.

In optional embodiments, the selected path selecting control in the extension window in the droplet editing interface may represent one type of droplet moving path information. That is, when the droplet editing interface includes two extension windows, the user may separately perform path selecting operations in the two extension windows so that the droplet moving paths may be separately set. In this case, one of the two droplet moving paths may be selected based on requirement to generate a corresponding driving signal so that the microfluidic chip can drive the droplet according to the driving signal.

In another optional embodiment, the selected path selecting control in the extension window in the droplet editing interface may represent a moving step in the droplet moving path information. That is, for example, the droplet editing interface includes three extension windows, the selected path selecting control in a first extension window may represent the start position in the moving path information, the selected path selecting control in a second extension window may represent the intermediate position in the moving path information, and the selected path selecting control in a third control window may represent the end position in the moving path information. In this case, the selected path selecting controls in the extension windows may constitute one type of droplet moving path information. Based on this, by the configuration of the number of selected path selecting controls contained in the extension windows and respective positions of the selected path selecting controls, not only the droplet can be driven to move in a set direction, but also the separation, merging, and the like of the droplet can be achieved correspondingly.

It can be understood that FIG. 16 illustratively shows one extension window as an example, and the droplet path editing interface in the embodiment of the present application may also include multiple extension windows. The display manner of the extension window may be set according to actual needs.

Optionally, the droplet path editing interface may also include a page selecting window; the page selecting window includes a page flipping control, a window total number display frame, and a window sequence display frame. In this case, the droplet driving method also includes displaying, in the window total number display frame, the total number of number of extension windows when the extension operation to extend the path planning window is received; and receiving a page-flipping selecting operation for the page flipping control, displaying an extension window corresponding to the page flipping operation in the path planning window, and displaying the extension sequence corresponding to a currently displayed extension window in the window sequence display frame.

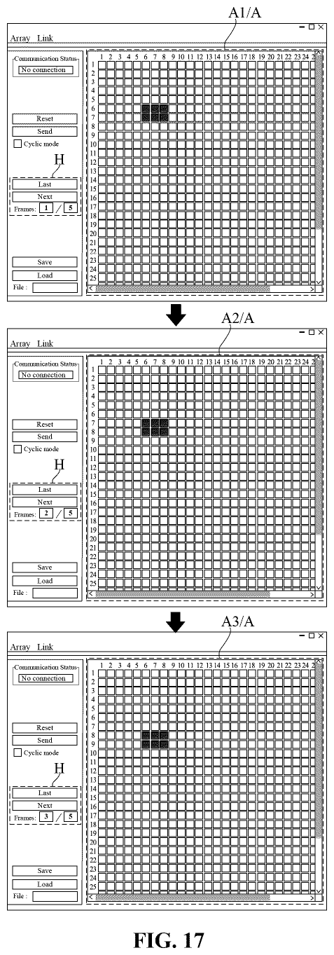

Illustratively, as shown in FIG. 17, the page selecting window H in the droplet path editing interface is located on a side of the path planning window (extension window) A, and the page selecting window H may include two page flipping controls Next and Last. When a page-flipping selecting operation is performed on the page flipping control Next, the displayed path planning window may be jumped from the current extension window to the next extension window. For example, when the current displayed path planning window is a first extension window, the path planning window may be jumped from the first extension window to a second extension window when a page-flipping selecting operation is performed on the page flipping control Next. Alternatively, when the currently displayed path planning window is the last extension window (for example, the N-th extension window), the path planning window may be jumped from the N-th extension window to the first extension window when a page-flipping selecting operation is performed on the page flipping control Next; when a page-flipping selecting operation is performed on the page flipping control Last, the displayed path planning window may be directly jumped from the currently displayed extension window to the last extension window (for example, the N-th extension window).

With reference to FIG. 17, the page selecting window H may also include two display frames, namely, a window total number display frame and a window sequence display frame. In this case, the total number of extension windows may be displayed in the corresponding window total number display frame, and the extension sequence of the currently displayed extension frame may be displayed in the sequence display frame. For example, if no extension operation is currently performed, the number of path planning windows that can be displayed in the droplet path editing interface may be 0 or 1. For example, the number of path planning windows that can be displayed in the droplet path editing interface is 1, the numbers in both the window total number display frame and the window sequence display frame are 1. After the user performs the extension operation for the first time, the number of path planning windows that can be displayed in the droplet path editing interface becomes 2, and in this case, the numbers in the window total number display frame and the window sequence display frame may both become 2. In this manner, each time the extension operation is performed, the number of path planning windows that can be displayed in the droplet path editing interface may be increased by 1, causing the numbers displayed in the window total number display frame and the window sequence display frame to be increased by one simultaneously. When a page-flipping selecting operation is performed on the page flipping control, the number in the window sequence display frame may be adjusted according to the jump situation. For example, when the currently displayed path planning window is a fourth extension window and the number of path planning windows that can be displayed in the droplet path editing interface is 4, if the page flipping operation is performed on the page flipping control Next, the number displayed in the window sequence display frame may change from 4 to 1, and the number 4 remains displayed in the window total number display frame. In this manner, the user may intuitively learn the number of currently extension windows and the extension sequence of the currently displayed extension window according to the numbers displayed in the display frames.

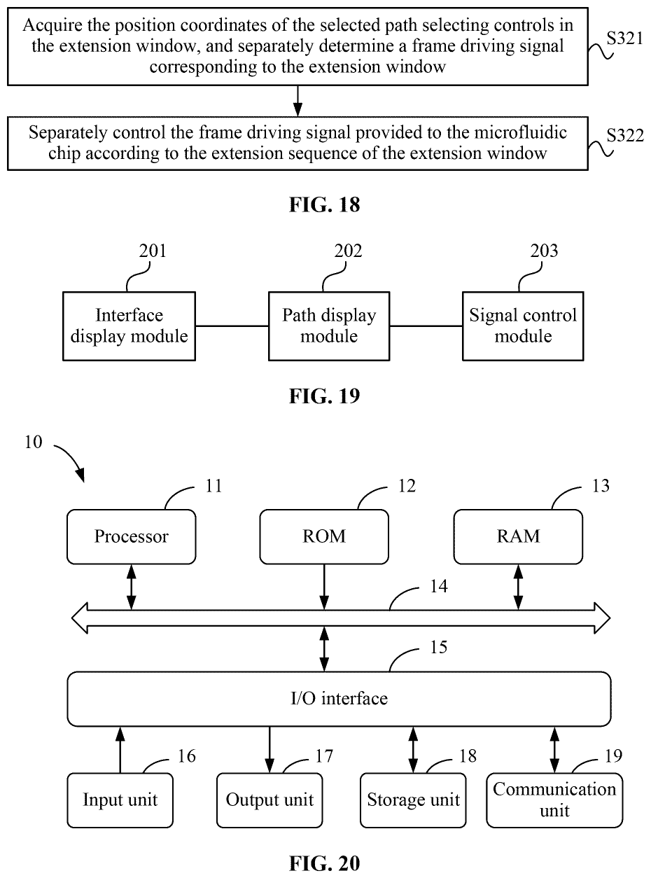

Optionally, when the path selecting operation includes the extension operation to extend the path planning window, the method for controlling a driving signal for the microfluidic chip includes first determining frame driving signals corresponding to the extension windows and then sequentially providing the frame driving signals to the microfluidic chip. As shown in FIG. 18, the method for controlling a driving signal of the microfluidic chip includes the steps below.

In S321, one or more position coordinates of one or more selected path selecting controls in each of the one or more extension windows are acquired, and one or more frame driving signals corresponding to the one or more extension windows are separately determined.

One or more selected path selecting controls may be provided in the extension window. In optional embodiments, the number of selected path selecting controls in the extension window may be equivalent to the size of the droplet. In another optional embodiment, the number of selected path selecting controls in the extension window may be smaller than the size of the droplet. In yet another optional embodiment, the number of selected path selecting controls in the extension window may also be greater than the size of the droplet.

Illustratively, with reference to FIG. 16, for example, the number of selected path selecting controls in the extension window is equivalent to the size of the droplet. If the size of the droplet is 3*2, the extension window may correspondingly include six selected path selecting controls arranged in a 3*2 array. When the row and the column where a path selecting control is located are used as the position coordinate of the path selecting control, the position coordinate of the path selecting control are unique. In this manner, the position coordinate of a selected path selecting window in the extension window can be determined by the selection of the row and the column where the selected path selecting control is located in the extension window. In addition, since driving electrodes of driving units in the microfluidic chip are set in a one-to-one correspondence with path selecting controls in the extension window, the moving path of the droplet in the microfluidic chip can be determined according to the position coordinate after the position coordinates of the one or more selected path selecting controls in the extension window are determined. Thus, the driving voltage of the driving electrode in the microfluidic chip can be determined. Based on this, after the position coordinates of the one or more selected path selecting controls in the extension window are determined, the driving signal provided to the microfluidic chip can be directly determined.

Correspondingly, when the extension window corresponds to a moving step of the droplet moving path, the frame driving signal generated based on the selection state of the path selecting control in the extension window may correspondingly generate one frame driving signal. For example, a first frame driving signal provided to the microfluidic chip may be generated based on the one or more position coordinates of the one or more selected path selecting controls in a first extension window, and a second frame driving signal provided to the microfluidic chip may be correspondingly generated based on the one or more position coordinates of the one or more selected path selecting controls in a second extension window.

Optionally, based on the preceding embodiments, the droplet driving method may also include the following: When the operation of selecting the path selecting control in the extension window is received, a first relationship table of one or more first relationship tables corresponding to an extension window of one or more extension windows is generated, and the one or more position coordinates of the one or more selected path selecting controls in the extension window is saved in the corresponding first relationship table in a one-to-one correspondence; and after the one or more first relationship tables corresponding to the one or more extension windows are generated, the generation sequences of the one or more first relationship tables and the one or more first relationship tables are saved in a second relationship table in a one-to-one correspondence.

The first relationship table includes the one or more position coordinates of the one or more selected path selecting controls in the extension window. The second relationship table is a mapping relationship table between the extension windows and the first relationship tables. For example, the position coordinates of the selected path selecting controls in the first extension window are saved in a first first relationship table. In the second relationship table, one first relationship table can be determined by finding the generation sequence “1” of the first extension window and determining the mapping result of “1”. The first relationship table is the first first relationship table. In the first first relationship table, the position coordinates of the selected path selecting controls in the first extension window may be determined, and based on the position coordinates of the selected path selecting controls in the first first relationship table, a first frame driving signal provided to the microfluidic chip can be further determined. In this manner, frame driving signals can be determined in a one-to-one correspondence by the corresponding mapping relationship so that when the microfluidic chip receives the frame driving signals, the microfluidic chip can drive the droplet to move along the set droplet moving path, thereby meeting the needs of diverse movement routes. It can be understood that both the first relationship table and the second relationship table may be set according to actual needs. In optional embodiments, at least one of the first relationship table or the second relationship table may be a hash table.

Optionally, acquiring the one or more position coordinates of the one or more selected path selecting control in the extension window and separately determining a frame driving signal corresponding to the extension window include: setting a storage value of each of storage units in a frame data buffer to a first storage value; sequentially extracting first relationship tables in the second relationship table according to the generation sequences; searching, according to the one or more position coordinates of the one or more selected path selecting controls stored in an extracted first relationship table, position coordinates of storage units corresponding to the position coordinates of the one or more selected path selecting controls in the frame data buffer and determining the position coordinates of the corresponding storage units as the position coordinates of first storage units; modifying the storage value of each of the first storage units to a second storage value; and using the modified storage values in the frame data buffer as a frame driving signal corresponding to the extracted first relationship table.

The position coordinates of storage units in the frame data buffer are in a one-to-one correspondence with the position coordinates of the one or more path selecting controls in the same extension window. The first storage value is different from the second storage value. For example, the first storage value is “0”, and the second storage value is “1”.

Illustratively, before the storage value of a storage unit in the frame data buffer is modified, the storage value of each of the storage units may be adjusted to the default storage value, that is, the first storage value, by writing or resetting. Thus, subsequent modification of the storage unit corresponding to a selected path selecting control is facilitated. In addition, since the position coordinates of the selected path selecting controls in the extension window are stored in the first relationship table, a mapping relationship between the generation sequence of the extension window and the first relationship table is a second relationship table, and based on this, the first relationship table corresponding to the extension window may be extracted according to the generation sequence of the extension window. For example, a first relationship table corresponding to a first extension window whose generation sequence is “1” is first extracted; based on the position coordinates of the selected path selecting controls stored in the first relationship table, the storage units whose storage value need to be modified in the frame data buffer are determined in a one-to-one correspondence, and the determined storage value of the storage units is correspondingly modified to a second storage value; then a first frame driving signal is generated based on the modified storage value of the storage units in the frame data buffer. After the first frame driving signal is provided to the microfluidic chip, the storage values of the storage units in the frame data buffer may be adjusted to the first storage value again. After the storage values of the storage units in the frame data buffer are adjusted to the first storage value, the first relationship table corresponding to a second extension window whose generation sequence is “2” may be extracted, and based on the position coordinates of the selected path selecting controls stored in the first relationship table, the storage units whose storage value need to be modified in the frame data buffer are determined in a one-to-one correspondence, and the determined storage value of the storage units is correspondingly determined to a second storage value; then a second frame driving signal is generated based on the modified storage value of the storage units in the frame data buffer. By analogy, after the driving signal of the previous frame is provided to the microfluidic chip, the storage values of the storage units in the frame data buffer may be reset, and then storage values of the storage units corresponding to the driving signal of the next frame are modified correspondingly. In this manner, it is helpful to reduce the number of frame data buffers, thereby reducing costs and improving the data processing efficiency.

In S322, the one or more frame driving signals provided to the microfluidic chip are sequentially controlled according to the extension sequences of the one or more extension windows.

When multiple extension windows are provided, multiple generated frame driving signals are also provided. In this case, the frame driving signals corresponding to the extension windows may be sequentially provided to the microfluidic chip according to the generation sequence of the extension windows so that the microfluidic chip drives the droplet to move along the droplet moving path set by the user. In this manner, the demand for any moving path of the droplet is met, and the application scenarios of the microfluidic chip are broadened. In addition, the frame driving signals are sequentially provided to the microfluidic chip so that the microfluidic chip receives the driving signals in frame-pair units, and a large storage space is not required in the microfluidic chip, which helps reduce the cost of the microfluidic chip.

On the basis of the preceding embodiments, optionally, with reference to FIG. 12 or FIG. 16, the droplet path editing interface may also include a path operating window F; the path operating window F may include a resetting control Reset. In this case, the droplet driving method may also include clearing the droplet moving path information displayed in the path planning window A when a data resetting operation for the reset control Reset is received.

The reset control Reset can clear the droplet moving path information set in the path planning window with one click so that when the user needs to re-edit the position of a selected path selecting control in the path planning window, the existing selected path selecting control in the path planning window may be changed to an unselected path selecting control by using the one-click clearing function of the reset control Reset. Thus, the user can edit again.

Optionally, with continued reference to FIG. 12 or FIG. 16, the droplet path editing interface may also include a path operating window F; the path operating window F may include a sending control Send. In this case, the droplet driving method may also include controlling the driving signal to be sent to the microfluidic chip when a data sending operation for the sending control Send is received.

The sending control Send can send the driving signal generated based on the position coordinates of a selected path selecting control in the path planning window to the microfluidic chip so that when the driving signal needs to be provided to the microfluidic chip, a data sending operation may be performed on the sending control Send. In this manner, the driving signal is sent to the microfluidic chip in a corresponding communication manner, and when the microfluidic chip receives the driving signal, the microfluidic chip can drive the droplet to move along the droplet moving path set by the user.

Optionally, the droplet driving method may also include displaying a data sending progress bar in the droplet path editing interface when the data sending operation for the sending control is received. In this manner, when the driving signal is provided to the microfluidic chip, the user can directly view the data sending progress bar in the droplet path editing interface to learn the driving signal sending progress in time, and thus, the user's next operation is facilitated.

Optionally, with continued reference to FIG. 12 or FIG. 16, the droplet path editing interface may also include a path operating window G; the path operating window G includes a saving control Save. In this case, the droplet driving method may also include saving the droplet moving path information in a saving manner and a saving path corresponding to the data saving operation when a data saving operation for the saving control Save is received. In this manner, the moving path information of the droplet displayed in the path planning window A can be saved in a selected storage path through the data saving operation for the saving control Save, so as to facilitate the subsequent call.

Optionally, with continued reference to FIG. 12 or FIG. 16, the path operating window F may also include a loading control Load and a loading path display frame File. In this case, the droplet driving method may also include when a data loading operation for the loading control Load is received, displaying, in the path planning window A, the droplet moving path information saved in a loading path in a loading manner and a loading path corresponding to the data loading operation, and displaying the loading path in the loading path display frame File. In this manner, when the corresponding storage path stores the set droplet moving path information, the loading control Load may be directly loaded so that the stored droplet moving path information is loaded in a corresponding loading path, and the loaded droplet moving path information is displayed in the path planning window A. Thus, the user does not need to reset the corresponding droplet moving path information in the path planning window A, which helps save time and simplify operations.

It can be understood that as shown in FIG. 12, when the droplet path editing interface is simultaneously provided with a path planning window A, an identification window B, a menu bar C, a communication display frame D, a parameter setting window E, and a path operating window F, the arrangement of the path planning window A, the identification window B, the menu bar C, the communication display frame D, the parameter setting window E, and the path operating window F may be set according to actual needs. In an example embodiment, the identification window B, the menu bar C, the communication display frame D, the parameter setting window E, and the path operating window F are located on a side of the path planning window A and may be arranged in a first direction, and the identification window B, the menu bar C, the communication display frame D, the parameter setting window E, and the path operating window F are all arranged in a second direction with the path planning window A, where the first direction and the second direction are perpendicular to each other. In other example embodiments, the relationship between the plates is not relatively fixed. The user may also adjust the relative position of the plates according to actual needs. Special limitation is not made in the embodiments of the present application on the premise that core application points of embodiments of the present application can be implemented.

It can also be understood that as shown in FIG. 16, when the droplet path editing interface is simultaneously provided with a path planning window A, a menu bar C, a communication display frame D, a parameter setting window E, a path operating window F, and a page selecting window H, the arrangement of the path planning window A, the menu bar C, the communication display frame D, the parameter setting window E, the path operating window F, and the page selecting window H may also be set according to actual needs. In an example embodiment, the menu bar C, the communication display frame D, the parameter setting window E, the path operating window F, and the page selecting window H are located on a side of the path planning window A and may be arranged in a first direction, and the menu bar C, the communication display frame D, the parameter setting window E, the path operating window F, and the page selecting window H are all arranged in a second direction with the path planning window A, where the first direction and the second direction are perpendicular to each other. In other example embodiments, the relationship between the plates is not relatively fixed. The user may also adjust the relative position of the plates according to actual needs. Special limitation is not made in the embodiments of the present application on the premise that core application points of embodiments of the present application can be implemented.

Based on the same inventive concept, embodiments of the present application also provide a droplet driving apparatus based on a microfluidic chip to drive the droplet to move in any path. The droplet driving apparatus based on a microfluidic chip according to the embodiments of the present application may be implemented by software and/or hardware and may be integrated into a host computer. FIG. 19 is a block diagram illustrating the structure of a droplet driving apparatus based on a microfluidic chip according to one or more embodiments of the present application. As shown in FIG. 19, the droplet driving apparatus based on a microfluidic chip includes an interface display module 201, a path display module 202, and a signal control module 203.

The interface display module 201 is configured to display a droplet path editing interface in response to a droplet path editing request; where the droplet path editing interface at least includes a path planning window.

The path display module 202 is configured to receive a path selecting operation in the path planning window and display, in the path planning window, the droplet moving path information corresponding to the path selecting operation.

The signal control module 203 is configured to control a driving signal for the microfluidic chip according to the droplet moving path information to drive a droplet to move along a moving path corresponding to the moving path information when the microfluidic chip receives the driving signal.

Optionally, the path selecting operation at least includes a start position selecting operation, an intermediate position selecting operation, and an end position selecting operation.

Optionally, the droplet path editing interface also includes a parameter setting window. In this case, the droplet driving apparatus also includes a parameter display module. The parameter display module is configured to receive a parameter setting operation in the parameter setting window and display, in the parameter setting window, the droplet parameter information corresponding to the parameter setting operation; the droplet parameter information includes the size of the droplet.

Optionally, the path planning window includes multiple path selecting controls arranged in an array, and the path selecting operation includes an operation of selecting a path selecting control; the signal control module 203 may include a coordinate acquisition sub-module, a driving signal determination sub-module, and a signal supply sub-module.

The coordinate acquisition sub-module is configured to separately acquire one or more position coordinates of one or more selected path selecting control displayed in the moving path information.

The driving signal determination sub-module is configured to separately extend the position coordinates of the one or more selected path selecting controls according to the size of the droplet and separately determine one or more driving signals corresponding to the one or more position coordinates of the selected path selections.

The signal supply sub-module is configured to control the one or more driving signal to be provided to the microfluidic chip in sequence.

Optionally, the selected path selecting control includes a first path selecting control, a second path selecting control, . . . and an N-th path selecting control corresponding to a start position, one or more intermediate positions, and an end position of the droplet; where N is a positive integer greater than or equal to 3. In this case, the driving signal determination sub-module includes a control traversal unit and a driving signal generation unit.

The control traversal unit is configured to traverse path selecting controls in a row direction and/or a column direction of an i-th path selecting control according to the size of the droplet by starting at a position coordinate of the i-th path selecting control until the number of traversed path selecting controls in the row direction and/or column direction is equal to the size of the droplet in the row direction and/or column direction.

The driving signal generation unit is configured to generate an i-th frame driving signal provided to the microfluidic chip according to the position coordinates of the traversed path selecting controls; where i is a positive integer greater than or equal to 1 and less than or equal to N.

Optionally, the driving signal generation unit is configured to perform the following operations: setting the storage value of each of storage units in a frame data buffer to a first storage value; where position coordinates of the storage units in the frame data buffer and the position coordinates of the path selecting controls in the path planning window are in a one-to-one correspondence, and the position coordinate of each of the traversed path selecting controls includes a row coordinate and a column coordinate; separately acquiring the position coordinates of the traversed path selecting controls in the row direction of the i-th path selecting control when traversing is performed in the row direction of the i-th path selecting control; searching, according to the position coordinates of the traversed path selecting controls, position coordinates of storage units corresponding to the position coordinates of the traversed path selecting controls in the frame data buffer and using the position coordinates of the corresponding storage units as position coordinates of first storage units; modifying the storage value of each of the first storage units to a second storage value; where the second storage value is not equal to the first storage value; and sequentially modifying a storage value of each of another storage units in a column direction of the storage units to the second storage value by taking each of the first storage units as a starting point, until in the column direction of each of the first storage units, the number of storage units whose storage value is the second storage value is equal to the size of the droplet in the column direction.

Optionally, the droplet driving apparatus also includes a coordinate storage module. The coordinate storage module is configured to: when a path selecting operation for the path planning window is received, sequentially store the position coordinate of the selected path selecting control in an SS queue according to the selection sequence of the path selecting control.

Optionally, the coordinate acquisition sub-module includes an element extraction unit and a coordinate determination unit.

The element extraction unit is configured to sequentially extract, from the SS queue, an element located at a first position of the SS queue.

The coordinate determination unit is configured to determine, according to the extracted element located at the first position of the SS queue, the position coordinate of the selected path selecting control.

Optionally, the droplet path editing interface also includes an identification window; the identification window displays a start color identification, an intermediate color identification, and an end color identification corresponding to the start position selecting operation, the intermediate position selecting operation, and the end position selecting operation, respectively. In this case, the droplet driving apparatus also includes a color display module. The color display module is configured to perform the following operations: when the start position selecting operation is received, displaying the same color as the start color identification at a start position operation location of the path planning window; when the intermediate position selecting operation is received, displaying the same color as the intermediate color identification at an intermediate position operation location of the path planning window; when the end position selecting operation is received, displaying the same color as the end color identification at an end position operation location of the path planning window.

Optionally, the path planning window includes multiple path selecting controls arranged in an array, and the path selecting operation includes an extension operation to extend the path planning window and an operation of selecting a path selecting control. In this case, the path display module 202 includes an extension window display sub-module and a control display sub-module.

The extension window display sub-module is configured to receive the extension operation to extend the path planning window and display one path planning window as an extension window.

The control display sub-module is configured to receive the operation of selecting the path selecting control in the extension window, and in the extension window, display one or more selected path selecting controls using a first preset identification and one or more unselected path selecting controls using a second preset identification.

The droplet moving path information includes the one or more selected path selecting controls separately displayed in the extension window.

Optionally, the signal control module 203 includes a frame driving signal acquisition sub-module and a frame driving signal supply sub-module.

The frame driving signal acquisition sub-module is configured to acquire the one or more position coordinates of the one or more selected path selecting controls in the extension window and separately determine a frame driving signal corresponding to the extension window.

The frame driving signal supply sub-module is configured to sequentially control a frame driving signal provided to the microfluidic chip according to the extension sequence of the extension window.

Optionally, the droplet driving apparatus also includes a first relationship table generation module and a second relationship table generation module.

The first relationship table generation module is configured to: when the operation of selecting the path selecting control in the extension window is received, generate a first relationship table corresponding to the extension window, and store the position coordinates of the one or more selected path selecting controls in the first relationship table in a one-to-one correspondence.

The second relationship table generation module is configured to: after the first relationship table corresponding to the extension window is generated, store the generation sequence of the first relationship table and the first relationship table in a second relationship table in a one-to-one correspondence.

Optionally, the frame driving signal acquisition sub-module includes a frame driving signal generation unit, a storage value modification unit, a position coordinate searching unit, a first relationship table extraction unit, and a storage value setting unit.

The storage value setting unit is configured to set the storage value of each of storage units in a frame data buffer to a first storage value; where the position coordinates of the one or more storage units in the frame data buffer are in a one-to-one correspondence with the position coordinates of path selecting controls in the same extension window.

The first relationship table extraction unit is used to sequentially extract a first relationship table in the second relationship table according to the generation sequence.

The position coordinate searching unit is used to search, according to the position coordinates of the one or more selected path selecting controls stored in an extracted first relationship table, position coordinates of storage units corresponding to the position coordinates of the one or more selected path selecting controls in the frame data buffer and determine the position coordinates of the corresponding storage units as the position coordinates of first storage units.

The storage value modification unit is configured to modify the storage value of each of the first storage units to a second storage value.

The frame driving signal generating unit is configured to use the modified data stored in the frame data buffer as a frame driving signal corresponding to the extracted first relationship table.

Optionally, the droplet path editing interface also includes a page selecting window, and the page selecting window includes a page flipping control, a window total number display frame, and a window sequence display frame; the droplet driving apparatus also includes an extension window display module and a sequence display module.

The extension window display module is configured to display, in the window total number display frame, the total number of windows corresponding to the number of extension windows when the extension operation to extend the path planning window is received.

The sequence display module is configured to receive a page-flipping selecting operation for the page flipping control, display an extension window corresponding to the page flipping operation in the path planning window, and display the extension sequence corresponding to a currently displayed extension window in the window sequence display frame.

Optionally, the droplet path editing interface also includes a path operating window; the path operating window includes a resetting control; the droplet driving apparatus also includes a clearing module. The clearing module is configured to reset clearing the droplet moving path information displayed in the path planning window when a data resetting operation for the reset control is received.

Optionally, the droplet path editing interface also includes a path operating window; the path operating window includes a sending control; the droplet driving apparatus also includes a sending module. The sending module is configured to control the driving signal to be sent to the microfluidic chip when a data sending operation for the sending control is received.

Optionally, the droplet driving apparatus also includes a progress bar display module. The progress bar display module is configured to display a data sending progress bar in the droplet path editing interface when the data sending operation for the sending control is received.

Optionally, the droplet path editing interface also includes a path operating window; the path operating window includes a saving control; the droplet driving apparatus also includes a saving module. The saving module is configured to save the droplet moving path information in a saving manner and a saving path corresponding to the data saving operation when a data saving operation for the saving control is received.

Optionally, the path operating window also includes a loading control and a loading path display frame; the droplet driving apparatus also includes a loading module. The loading module is configured to: when a data loading operation for the loading control is received, display, in the path planning window, the droplet moving path information saved in a loading path in a loading manner and a loading path corresponding to the data loading operation, and display the loading path in the loading path display frame.

Optionally, the droplet path editing interface also includes a menu bar and a communication display frame; the droplet driving apparatus also includes a selection operation module and/or a communication operation module.

The selection operation module is configured to receive an array selecting operation for the menu bar, and display, in the path planning window, a path selecting control array corresponding to the array selecting operation.

The communication operation module is configured to receive a communication selecting operation for the menu bar, display, in a communication manner display frame, a communication manner corresponding to the communication selecting operation, and determine, according to the communication manner, a sending path for sending the driving signal to the microfluidic chip.

Optionally, the microfluidic chip includes multiple driving signal terminals, multiple multiplex selection circuits, and multiple driving signal lines, and a multiplex selection circuit includes multiple switches; an output terminal of a switch is electrically connected to a driving signal line; in the same multiplex selection circuit, an input terminal of the switch is electrically connected to the same driving signal terminal, and a control terminal of the switch receives different switch control signals; a switch control signal controls the time-sharing turn-on of a switch in the same multiplex selection circuit; the driving signal includes multiple frame driving signals; a frame driving signal includes multiple subframe data that are in a one-to-one correspondence with the multiple switches in the multiplex selection circuit; and the signal control module 203 also includes a subframe data supply sub-module configured to provide the subframe data corresponding to the currently turned on switch to the microfluidic chip in sequence in the turn-on sequence of the switch.

The droplet driving apparatus provided by the embodiments of the present application may execute the droplet driving method provided by the embodiments of the application. The droplet driving apparatus has a corresponding structure capable of executing the droplet driving method provided by the embodiments of the application and can achieve the same beneficial effects as the droplet driving method provided by the embodiments of the present application. The similarities may be understood with reference to the preceding explanation of the display panel and will not be repeated herein.

Based on the same inventive concept, embodiments of the present application also provide an electronic device. The electronic device includes at least one processor and a memory communicatively connected to the at least one processor. The memory stores a computer program executable by the at least one processor. The computer program is configured to, when executed by the at least one processor, cause the at least one processor to execute the droplet driving method described in the embodiments of the present application. The electronic device may include but is not limited to a host computer.

FIG. 20 is a diagram illustrating the structure of an electronic device 10 that can implement the embodiments of the present application. The electronic device are intended to represent various forms of digital computers, for example, a laptop computer, a desktop computer, a worktable, a personal digital assistant, a server, a blade server, a mainframe computer, or other applicable computers. The electronic device may also represent various forms of mobile apparatuses such as a personal digital processing apparatus, a cellular phone, a smart phone, a wearable device (for example, a helmet, glasses, a watch), and other similar computing apparatuses. The components shown herein, their connections and relationships, and their functions, are by way of examples only and are not intended to limit implementations of the present application described and/or claimed herein.

As shown in FIG. 20, the electronic device 10 includes at least one processor 11 and a memory in a communication connection with the at least one processor 11, such as a read-only memory (ROM) 12 and a random-access memory (RAM) 13. The memory stores a computer program executable by the at least one processor. The processor 11 may perform various appropriate actions and processes according to computer programs stored in a read-only memory (ROM) 12 or loaded from a storage unit 18 into a random-access memory (RAM) 13. The RAM 13 may also store various programs and data required for the operation of the electronic device 10. The processor 11, the ROM 12, and the RAM 13 are connected to each other through a bus 14. An input/output (I/O) interface 15 is also connected to the bus 14.

Multiple components in the electronic device 10 are connected to the I/O interface 15, including an input unit 16, such as a keyboard or a mouse; an output unit 17, such as various types of displays or speakers; a storage unit 18, such as a magnetic disk or an optical disk; and a communication unit 19, such as a network card, a modem, or a wireless communication transceiver. The communication unit 19 allows the electronic device 10 to exchange information/data with other devices through a computer network such as the Internet and/or various telecommunication networks.

The processor 11 may be various general-purpose and/or special-purpose processing components having processing and computing capabilities. Some examples of the processor 11 include but are not limited to, a central processing unit (CPU), a graphics processing unit (GPU), various dedicated artificial intelligence (AI) computing chips, various processors running machine learning model algorithms, a digital signal processor (DSP), and any suitable processors, controllers, and microcontrollers. The processor 11 performs various methods and processes described above, such as a droplet driving method.

In some embodiments, the droplet driving method may be implemented as a computer program tangibly embodied in a computer-readable storage medium such as the storage unit 18. In some embodiments, part or all of the computer program may be loaded and/or installed on the electronic device 10 via the ROM 12 and/or the communication unit 19. When the computer program is loaded into the RAM 13 and executed by the processor 11, one or more steps of the droplet driving method described above may be performed. Optionally, in other embodiments, the processor 11 may be configured to perform the droplet driving method by any other suitable means (for example, by means of firmware).

Various implementations of the systems and techniques described above herein may be implemented in digital electronic circuitry, integrated circuitry, a field programmable gate array (FPGA), an application specific integrated circuit (ASIC), an application specific standard product (ASSP), a system on chip (SOC), a complex programmable logic device (CPLD), a computer hardware, a firmware, a software, and/or combinations thereof. The various implementations may include an implementation in one or more computer programs that may be executable and/or interpretable on a programmable system including at least one programmable processor. The programmable processor may be special-purpose or general-purpose for receiving data and instructions from a memory system, at least one input apparatus, and at least one output apparatus and transmitting the data and instructions to the memory system, the at least one input apparatus, and the at least one output apparatus.

The computer program for implementing the method of the present application may be written in any combination of one or more programming languages. These computer programs may be provided to a processor of a general-purpose computer, special-purpose computer, or other programmable data processing apparatus such that the computer programs, when executed by the processor, cause the functions/operations specified in flowcharts and/or block diagrams to be implemented. The computer program may be executed entirely or partly on the machine, as a stand-alone software package partly on the machine and partly on a remote machine, or entirely on the remote machine or server.

Based on the same inventive concept, embodiments of the present application also provide a computer-readable storage medium. In the context of the present application, a computer-readable storage medium may be a tangible medium that may contain or store a computer program for use by or in conjunction with an instruction execution system, apparatus, or device. The computer-readable storage medium may include, but is not limited to, electronic, magnetic, optical, electromagnetic, infrared, or semiconductor systems, apparatuses, or devices, or any suitable combination thereof. Optionally, the computer-readable storage medium may be a machine-readable signal medium. Examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof.

To provide interaction with a user, the systems and techniques described herein may be implemented on an electronic device. The electronic device has a display device (for example, CRT (cathode ray tube) or LCD (liquid crystal display) monitor) for displaying information to the user; and a keyboard and pointing apparatus (for example, a mouse or a trackball) through which a user can provide input to the electronic device. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

The computing system may include a client and a server. A client and a server are generally remote from each other and typically interact through a communication network. The relationship between the client and the server arises by virtue of computer programs running on respective computers and having a client-server relationship with each other. The server, which may be a cloud server and is also referred to as a cloud computing server or a cloud host, is a host product in a cloud computing service system. The server solves the problems of difficult management and weak service scalability in the service of a related physical host and a related VPS.

Based on the same inventive concept, embodiments of the present application also provide a droplet driving system. The droplet driving system includes a microfluidic chip and a host computer. The host computer is connected to the microfluidic chip and is used to execute the droplet driving method provided by the embodiments of the present application. Therefore, the droplet driving system also has the beneficial effects of the droplet driving method described in the preceding embodiments, and for the same details, reference may be made to the description of the preceding display panel, and repetition will not be made herein.

It is to be understood that various forms of processes shown above may be adopted with steps reordered, added, or deleted. For example, the steps described in the present application may be performed in parallel, sequentially, or in different orders, as long as the desired results of the technical solutions of the present application can be achieved, and no limitation is imposed herein.

It is to be noted that the above are only preferred embodiments of the present application and the technical principles used therein. It is to be understood by those skilled in the art that the present application is not limited to the embodiments described herein. For those skilled in the art, various apparent modifications, adaptations, and substitutions may be made without departing from the scope of the present application. Therefore, while the present application is described in detail via the preceding embodiments, the present application is not limited to the preceding embodiments and may include more equivalent embodiments without departing from the concept of the present application. The scope of the present application is determined by the scope of the appended claims.

What is claimed is:

1. A droplet driving method based on a microfluidic chip, comprising:
displaying a droplet path editing interface in response to a droplet path editing request; wherein the droplet path editing interface at least comprises a path planning window;
receiving a path selecting operation in the path planning window, and displaying, in the path planning window, droplet moving path information corresponding to the path selecting operation; and
controlling a driving signal for the microfluidic chip according to the droplet moving path information to drive a droplet to move along a moving path corresponding to the moving path information.

2. The droplet driving method based on the microfluidic chip of claim 1, wherein the path selecting operation at least comprises a start position selecting operation, an intermediate position selecting operation, and an end position selecting operation.

3. The droplet driving method of claim 1, wherein the droplet path editing interface further comprises a parameter setting window; and
wherein the droplet driving method further comprises:
receiving a parameter setting operation in the parameter setting window, and displaying, in the parameter setting window, droplet parameter information corresponding to the parameter setting operation; wherein the droplet parameter information comprises a size of the droplet.

4. The droplet driving method of claim 3, wherein the path planning window comprises a plurality of path selecting controls arranged in an array, and the path selecting operation comprises an operation of selecting a path selecting control of the plurality of path selecting controls; and
wherein controlling the driving signal provided to the microfluidic chip according to the droplet moving path information comprises:
separately acquiring position coordinates of selected path selecting controls displayed in the moving path information;
separately extending the position coordinates of the selected path selecting controls according to the size of the droplet, and separately determining driving signals corresponding to the position coordinates of the selected path selecting controls; and
controlling the driving signals to be provided to the microfluidic chip in sequence.

5. The droplet driving method of claim 4, wherein the selected path selecting controls comprise a first path selecting control, a second path selecting control, . . . and an N-th path selecting control corresponding to a start position, at least one intermediate position, and an end position of the droplet respectively; wherein N is a positive integer greater than or equal to 3; and
wherein extending the position coordinates of the selected path selecting controls according to the size of the droplet, and determining the driving signals corresponding to the position coordinates of the selected path selections comprises:
traversing path selecting controls in a row direction and/or a column direction of an i-th path selecting control of the selected path selecting controls, according to the size of the droplet by starting at a position coordinate of the i-th path selecting control, until a number of traversed path selecting controls in the row direction and/or column direction is equal to a size of the droplet in the row direction and/or column direction; and
generating an i-th frame driving signal provided to the microfluidic chip according to position coordinates of the traversed path selecting controls; wherein i is a positive integer greater than or equal to 1 and less than or equal to N.

6. The droplet driving method of claim 5, wherein generating the i-th frame driving signal provided to the microfluidic chip according to the position coordinates of the traversed path selecting controls comprises:
setting a storage value of each of storage units in a frame data buffer to a first storage value;
wherein position coordinates of the storage units in the frame data buffer and position coordinates of the path selecting controls in the path planning window are in a one-to-one correspondence; and a position coordinate of each of the traversed path selecting controls comprises a row coordinate and a column coordinate;
separately acquiring the position coordinates of the traversed path selecting controls in the row direction of the i-th path selecting control in response to that traversing is performed in the row direction of the i-th path selecting control;
searching, according to the position coordinates of the traversed path selecting controls in the row direction of the i-th path selecting control, position coordinates of storage units in the frame data buffer corresponding to the position coordinates of the traversed path selecting controls in the row direction of the i-th path selecting control, and determining the position coordinates of the corresponding storage units in the frame data buffer as position coordinates of first storage units;
modifying the storage value of each of the first storage units to a second storage value;
wherein the second storage value is not equal to the first storage value; and
sequentially modifying a storage value of each of another storage units in a column direction of each of the first storage units to the second storage value by taking each of the first storage units as a starting point, until in the column direction of each of the first storage units, a number of storage units with the second storage value is equal to the size of the droplet in the column direction.

7. The droplet driving method of claim 4, further comprising:
in response to receiving a path selecting operation in the path planning window, sequentially storing the position coordinates of the selected path selecting controls in an SS queue according to selection sequences of the selected path selecting controls.

8. The droplet driving method of claim 7, wherein separately acquiring the position coordinates of the selected path selecting controls displayed in the moving path information comprises:
sequentially extracting, from the SS queue, an element located at a head position of the SS queue; and
determining, according to the extracted element located at the head position of the SS queue, the position coordinates of the selected path selecting controls.

9. The droplet driving method of claim 2, wherein the droplet path editing interface further comprises an identification window; and
the identification window displays a start color identification, an intermediate color identification, and an end color identification corresponding to the start position selecting operation, the intermediate position selecting operation, and the end position selecting operation, respectively;
in response to receiving the start position selecting operation, a same color as the start color identification is displayed at a start position selected by the start position selecting operation in the path planning window;
in response to receiving the intermediate position selecting operation, a same color as the intermediate color identification is displayed at an intermediate position selected by the intermediate position selecting operation in the path planning window; and
in response to receiving the end position selecting operation, a same color as the end color identification is displayed at an end position selected by the end position selecting operation in the path planning window.

10. The droplet driving method of claim 1, wherein the path planning window comprises a plurality of path selecting controls arranged in an array; and
the path selecting operation comprises an extension operation to extend the path planning window and an operation of selecting a path selecting control of the plurality of path selecting controls; and
wherein receiving the path selecting operation in the path planning window and displaying the droplet moving path information corresponding to the path selecting operation in the path planning window comprise:
receiving the extension operation to extend the path planning window, and displaying one path planning window as an extension window of a plurality of extension windows; and
receiving the operation of selecting the path selecting control in the extension window, and separately displaying at least one selected path selecting control using a first preset identification and at least one unselected path selecting control using a second preset identification in the extension window;
wherein the droplet moving path information comprises the at least one selected path selecting control separately displayed in the extension window.

11. The droplet driving method of claim 10, wherein controlling the driving signal for the microfluidic chip according to the droplet moving path information comprises:
acquiring a position coordinate of the at least one selected path selecting control in each of the extension windows, and separately determining frame driving signals corresponding to the extension windows; and
sequentially controlling the frame driving signals provided to the microfluidic chip according to extension sequences of the extension windows.

12. The droplet driving method of claim 10, further comprising:
in response to receiving the operation of selecting the path selecting control in the extension window, generating a first relationship table corresponding to the extension window, and storing the position coordinate of the at least one selected path selecting control of the extension window in the first relationship table; and
after first relationship tables corresponding to the extension windows are generated, storing generation sequences of the first relationship tables and the first relationship tables in a second relationship table in a one-to-one correspondence.

13. The droplet driving method of claim 12, wherein acquiring the position coordinate of the at least one selected path selecting control in each of the extension windows and separately determining frame driving signals corresponding to the extension windows comprise:
setting a storage value of each of storage units in a frame data buffer to a first storage value;
wherein position coordinates of the storage units in the frame data buffer are in a one-to-one correspondence with position coordinates of path selecting controls in a same extension window of the extension windows;
sequentially extracting a first relationship table in the second relationship table according to the generation sequences;
searching, according to position coordinates of selected path selecting controls stored in the extracted first relationship table, position coordinates of storage units in the frame data buffer corresponding to the position coordinates of the selected path selecting controls stored in the extracted first relationship table, and determining the position coordinates of the corresponding storage units as position coordinates of first storage units;
modifying a storage value of each of the first storage units to a second storage value; and
using the modified storage values stored in the frame data buffer as a frame driving signal corresponding to the extracted first relationship table.

14. The droplet driving method of claim 10, wherein the droplet path editing interface further comprises a page selecting window; and
the page selecting window comprises a page flipping control, a window total number display frame, and a window sequence display frame; and
wherein the droplet driving method further comprises:
displaying, in the window total number display frame, a total number of the extension windows in response to receiving the extension operation to extend the path planning window; and
receiving a page-flipping selecting operation for the page flipping control, displaying an extension window corresponding to the page flipping operation in the path planning window, and displaying an extension sequence corresponding to a currently displayed extension window in the window sequence display frame.

15. The droplet driving method of claim 1, wherein the droplet path editing interface further comprises a path operating window, and the path operating window comprises a reset control; and
wherein the droplet driving method further comprises:
clearing the droplet moving path information displayed in the path planning window in response to receiving a data resetting operation for the reset control; and/or
wherein the droplet path editing interface further comprises a path operating window, and the path operating window comprises a sending control; and the droplet driving method further comprises:
controlling the driving signal to be sent to the microfluidic chip in response to receiving a data sending operation for the sending control; and/or
wherein the droplet path editing interface further comprises a path operating window; and the path operating window comprises a saving control; and the droplet driving method further comprises:
saving the droplet moving path information in a saving manner and a saving path corresponding to the data saving operation in response to receiving a data saving operation for the saving control; and/or
wherein the droplet path editing interface further comprises a menu bar and a communication display frame; and the droplet driving method further comprises:
receiving an array selecting operation in the menu bar, and displaying, in the path planning window, a path selecting control array corresponding to the array selecting operation; and/or
receiving a communication selecting operation in the menu bar, displaying, in a communication display frame, a communication manner corresponding to the communication selecting operation, and determining, according to the communication manner, a sending path for sending the driving signal to the microfluidic chip.

16. The droplet driving method of claim 1, wherein the microfluidic chip comprises a plurality of driving signal terminals, a plurality of multiplex selection circuits, and a plurality of driving signal lines;
a multiplex selection circuit of the plurality of multiplex selection circuits comprises a plurality of switches;
an output terminal of a switch of the plurality of switches is electrically connected to a driving signal line of the plurality of driving signal lines;
in the multiplex selection circuit, input terminals of the plurality of switches are electrically connected to a same driving signal terminal, control terminals of the plurality of switches are configured to receive different switch control signals, and the switch control signals are configured to control time-sharing turn-on of the plurality of switches in the multiplex selection circuit;
the driving signal comprises a plurality of frame driving signals; and a frame driving signal of the plurality of frame driving signals comprises a plurality of subframes that are in a one-to-one correspondence with the plurality of switches in the multiplex selection circuit; and
wherein controlling the driving signal provided to the microfluidic chip comprises:
sequentially providing, in a sequence in which the plurality of switches are turned on, a subframe corresponding to a currently turned-on switch to the microfluidic chip.

17. A droplet driving apparatus based on a microfluidic chip, comprising:
an interface display module configured to display a droplet path editing interface in response to a droplet path editing request; wherein the droplet path editing interface at least comprises a path planning window;
a path display module configured to receive a path selecting operation in the path planning window and display, in the path planning window, droplet moving path information corresponding to the path selecting operation; and
a signal control module configured to control a driving signal for the microfluidic chip according to the droplet moving path information to drive a droplet to move along a moving path corresponding to the moving path information.

18. An electronic device, comprising:
at least one processor; and
a memory in a communication connection with the at least one processor; wherein
the memory stores a computer program executable by the at least one processor, and the computer program is configured to, when executed by the at least one processor, cause the electronic device to execute the droplet driving method of claim 1.

19. A droplet driving system, comprising a microfluidic chip and a host computer;
wherein the host computer is connected to the microfluidic chip; and the host computer is configured to execute a droplet driving method based on the microfluidic chip;
wherein the droplet driving method comprises:
displaying a droplet path editing interface in response to a droplet path editing request;
wherein the droplet path editing interface at least comprises a path planning window;
receiving a path selecting operation in the path planning window, and displaying, in the path planning window, droplet moving path information corresponding to the path selecting operation; and
controlling a driving signal for the microfluidic chip according to the droplet moving path information to drive a droplet to move along a moving path corresponding to the moving path information.

20. A non-transitory computer-readable storage medium, storing computer instructions that executed by a processor, implement the droplet driving method of claim 1.
